(19) United States
(12) Patent Application Publication
(10) Pub. No.: US 2025/0159760 A1
(43) Pub. Date: May 15, 2025

(54) CONNECTED ECOSYSTEM COMMUNICATION FOR AQUATIC EQUIPMENT

(71) Applicant: Pentair Water Pool & Spa, Inc., Cary, NC (US)

(72) Inventor: Keith Lewis, New Hill, NC (US)

(21) Appl. No.: 18/948,384

(22) Filed: Nov. 14, 2024

Related U.S. Application Data
(60) Provisional application No. 63/598,765, filed on Nov. 14, 2023.

(51) Int. Cl. H04W 84/18; E04H 4/14

(52) U.S. Cl. CPC H04W 84/18; E04H 4/14

(57) ABSTRACT

A system for aquatic equipment is provided. The aquatic equipment includes a plurality of system components of a connected system of the aquatic equipment, wherein at least a subset of the plurality of system components is communicatively coupled in a mesh network, and wherein a first system component of the plurality of system components is a root node of the mesh network. The aquatic equipment includes at least one sensing device adapted to capture sensor data associated with at least one system component of the plurality of system components, wherein the root node of the mesh network is adapted to communicate at least a subset of the sensor data to at least one other system component of the plurality of system components.

### CROSS REFERENCE TO RELATED APPLICATIONS

The present Application for Patent claims the benefit of U.S. Non-Provisional Patent Application No. 63/598,765 entitled “CONNECTED ECOSYSTEM COMMUNICATION FOR AQUATIC EQUIPMENT,” filed Nov. 14, 2023, the contents of which are incorporated by reference for all purposes.

### FIELD OF DISCLOSURE

The present disclosure relates generally to aquatic equipment systems, and more specifically to supporting the interconnected components of an aquatic equipment system and the addition thereof.

### BACKGROUND

Many aquatic equipment systems include system components that have individualized operating parameters and data elements. Additionally, many aquatic equipment systems utilize manual configuration for new system components when the components are added into the existing system. Existing systems are limited in their monitoring, analytic, and communication capabilities, in part because system components typically rely on a single control panel, broker, or router in order to connect to the system or communicate with other system components. There is also an ongoing need to monitor the aquatic equipment of an interconnected system and allow the individual system components to directly manage data elements and communication tasks in order to update the operating parameters of one or more system components based on the interconnected system configuration and newly added system components to improve system efficiency and prolong the life of the system components. Further, there is also a need for automatic configuration of new system components and efficient data exchange between system components to implement system updates.

Existing systems lack the processing systems, including data gathering and analytics techniques to monitor a connected aquatic system, automatically detect and configure new system components, and update the operating parameters of one or more of the existing and newly added system components in response to the added component(s). Furthermore, there is a need to provide an improved monitoring system that can work with multiple system components and not only for a single device, and that is adapted, scaled, and can accommodate different users, devices, manufacturers, and system configurations.

### SUMMARY

Examples described herein are generally directed to an intelligently connected aquatic equipment monitoring system. The connected system comprises system components, like pool and spa devices, which are designed to detect the presence of other system components, configure new system components, and update the operating parameters or other data sets of the system components to improve overall system performance and reliability. More specifically, the system components can connect to and communicate with each other directly via a mesh-style network paradigm. The system components can collect, store, and share data sets, which can then be processed to provide the data sets to other system components. The data sets can include an identification element and one or more operating parameters, topics, or updates relating to the system components, or data sets associated with the system component. The information in the data set can be collected using a sensing device.

In some examples, a method for monitoring and updating aquatic equipment comprises capturing the operating parameters with a sensing device integrated into a user device or connected to the system components, like pool equipment. The operating parameters can be stored in one or more datasets in a database, lookup table, locally on the system component, in a cloud storage system, on one or more memory units, or a combination thereof. In some examples, one or more devices can operate as a root node of the mesh-style network system and can communicate information, including data sets, to the backend network and the other system components in the connected system. In some examples, the root node is designed to aggregate data sets and other information and communicate with the backend server.

In some examples, a method for automatically configuring a new system component comprises an existing system component already adopted to the mesh-style network system and the new system component broadcasting an introduction packet including one or more data sets. In response to receiving the introduction packet from the new system component, the existing system component transmits a welcome packet comprising information about all, or at least some, existing system components connected to the connected system. The new system component examines the list of existing system components and subscribes to topics relevant to the new system component. The subscription information and topic selection are stored in a lookup table and transmitted via the existing system components to the other system component on the network and to a root node.

In some examples, a method for detecting and monitoring aquatic equipment comprises capturing the data sets with a sensing device integrated into a user device or connected to the pool components. The data sets can be stored in a database, lookup table, locally on the system component, in a cloud storage system, or similar. In some examples, the database can be located in a processing module, for example in a processor of the system engine of the system component. The processing module can access a stored lookup table that relates the pool component to the identification element and the operating parameters. In some examples, the data sets are stored on a cloud network and designed to be accessed by the individual system components in order to communicate updates to the data sets, including topic updates, to other system components of the connected system. The mesh-style connection of the system components provides efficient data exchange between the system components of the connected system.

In some examples, a system for aquatic equipment is provided. The system may include a plurality of system components of a connected system of the aquatic equipment, wherein at least a subset of the plurality of system components are communicatively coupled in a mesh network, and wherein a first system component of the plurality of system components is provided in the form of a root node of the mesh network. The system may also include at least one sensing device adapted to capture sensor data associated with at least one system component of the plurality of system components, wherein the root node of the mesh network is adapted to communicate at least a subset of the sensor data to at least one other system component of the plurality of system components.

In some instances, the system may further include a new system component, wherein the new system component is adapted to transmit an introduction packet including at least one data set, and receive a welcome packet comprising information associated with the plurality of system components. In some examples, the system may further include at least one memory unit adapted to store at least one operating parameter associated with the sensor data in at least one dataset in a database or a lookup table.

In other examples, the system may further include a controller in communication with at least a subset of the system components that is adapted to retrieve at least one information element from the at least one data set stored at the at least one memory unit, and output the at least one information element to at least a subset of the plurality of system components. In some examples, the root node of the mesh network is adapted to communicate at least the subset of sensor data to a cloud network. The root node of the mesh network may be adapted to aggregate at least one data set from the sensor data and communicate the at least one data set to a backend server.

In some examples, the at least one sensing device is integrated into a user device or connected to at least one system component of the plurality of system components. The plurality of system components may include two or more of at least one of a pool pump, a booster pump, a filter, a solar controller, a solar panel, a heater, a sanitizer, a water quality monitor, a pH regulator, a water feature, a pool cleaner, a pool skimmer, a pool drain, a pool light, and a salt chlorine generator.

A method for monitoring and updating aquatic equipment is also provided. The method may include receiving sensor data from at least one sensing device, wherein the sensor data is associated with at least a first system component of a plurality of system components, the plurality of system components is communicatively coupled in a mesh network, and at least one operating parameter is based at least in part on the sensor data. The method may also include communicating at least one operating parameter to the first system component of the plurality of system components via a second system component of the plurality of system components, wherein the second system component is provided in the form of a root node of the mesh network. The method may also include outputting the at least one operating parameter to at least one of a network device or at least one memory unit.

In some examples, the method may further include aggregating at least one data set from the sensor data and outputting the at least one data set to a backend server communicatively coupled with at least the root node of the mesh network.

In another example, the method may include receiving a request from at least a third system component of the plurality of system components for information related to at least one operating parameter associated with the third system component of the plurality of system components. The method may include receiving at least one data set associated with the at least one operating parameter from at least one of the network devices or the at least one memory unit based at least in part on the request. The method may further include outputting the at least one data set associated with the at least one operating parameter to the third system component of the plurality of system components.

Other examples of the method include receiving a request to subscribe a third system component of the plurality of system components to a topic update and outputting at least one operating parameter associated with the sensor data and related to the topic update to the third system component of the plurality of system components based at least in part on the request to subscribe.

In some examples, the method further includes storing the sensor data with at least one identification element associated with the sensor data in at least one memory unit, wherein each of the at least one identification elements are associated with one system component of the plurality of system components. In some examples, the method further includes performing an analytical analysis of the sensor data and outputting an instruction to at least one of the plurality of system components to adjust at least one setting based at least in part on the analytical analysis of the sensor data.

A method for configuring a new system component for an aquatic application is provided. The method may include receiving an introduction packet for the new system component at a first system component of a plurality of system components, wherein the introduction packet includes at least one data sets associated with the new system component. The method may further include outputting a welcome packet comprising information associated with the plurality of system components, wherein the plurality of system components and the new system component are defined by a mesh network. The method may further include receiving a subscription request from the new system component to subscribe to information related to a topic selection of at least one topic associated with the plurality of system components.

In some examples, the method may include outputting information related to the at least one topic to the new system component based on the subscription request. The method may further include storing subscription information associated with the subscription request and the topic selection in a database stored in at least one memory unit. The method may further include receiving sensor data from at least one sensing device associated with at least one of the plurality of system components, wherein the information related to the topic selection is based at least in part on the sensor data.

In other examples, the method may include aggregating at least one data set from the sensor data and outputting the at least one data set to a backend server communicatively coupled with at least a root node of the mesh network. The method may include outputting an indication to a first system component of the plurality of system components to update at least one setting at the first system component based at least in part on the sensor data.

### DESCRIPTION OF THE DRAWINGS

FIG. 1 is a schematic diagram of an example connected aquatic system according to disclosed examples;

FIG. 2 is a schematic diagram of another example connected aquatic system of FIG. 1;

FIG. 3 is a block diagram of an example aquatic equipment portion of the connected aquatic system of FIG. 1;

FIG. 4 is a block diagram of an example schematic of system components of the connected aquatic system of FIG. 1;

FIG. 5 is a block diagram of an example control system of the connected aquatic system of FIG. 1;

FIG. 6 is a flow diagram of an example system component configuration process of the connected aquatic system of FIG. 1;

FIG. 7 is a flow diagram of an example system component identification process according to disclosed examples;

FIG. 8 is a flow diagram of an example system component update process of the connected aquatic system of FIG. 1;

FIG. 9 is a flow diagram of an example subscription process for updating system components of the connected aquatic system of FIG. 1;

FIG. 10 is a flow diagram of an example process for monitoring and updating aquatic equipment of the connected aquatic system of FIG. 1; and

FIG. 11 is a flow diagram of an example process for configuring a new system component the connected aquatic system of FIG. 1.

### DETAILED DESCRIPTION

Before any examples of the system are explained in detail, it is to be understood that the system is not limited in its application to the details of construction and the arrangement of components set forth in the following description or illustrated in the following drawings. The system is capable of other examples and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use examples of the system. Various modifications to the illustrated examples will be readily apparent to those skilled in the art, and the generic principles herein can be applied to other examples and applications without departing from examples of the system. Thus, examples of the system are not intended to be limited to examples shown but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the system. Skilled artisans will recognize the examples provided herein have many useful alternatives and fall within the scope of examples of the system.

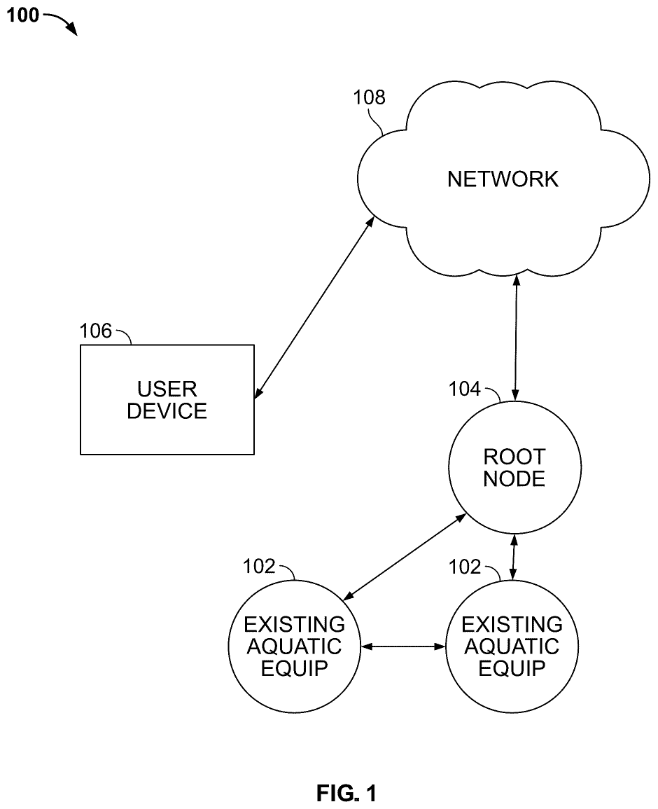

FIG. 1 illustrates an exemplary connected aquatic system 100 (hereinafter “connected system”), according to disclosed examples. When used throughout the disclosure, it will be understood that an “aquatic system” or “aquatic application” can include, for example, a pool or spa system, or similar. More particularly, the aquatic application or aquatic system may be provided as a swimming pool, a hot tub, a spa, a plunge pool, and other recreational water venues not specifically discussed herein.

As seen in FIG. 1, the connected system 100 may include one or more aquatic equipment system components 102, a root node 104, a user device 106, and a network 108. In some examples, the connected system 100 is designed to communicate with one or more third-party systems.

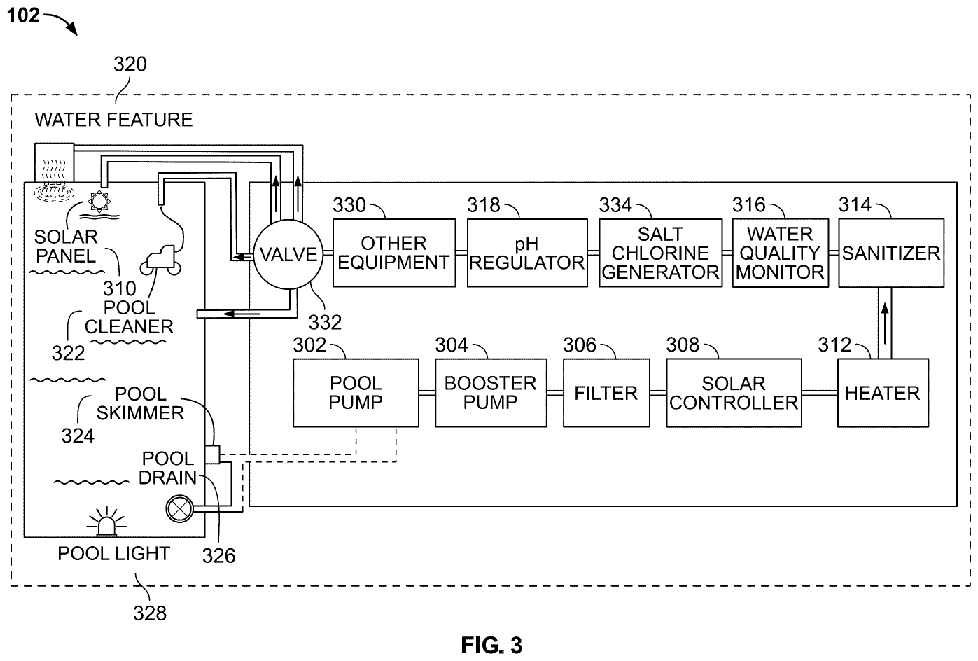

Each aquatic equipment system component 102 (hereinafter “system component”) may include any residential device having a communication port, radio, wired, or wireless communication module. Furthermore, as described in more detail in connection with FIG. 3, the system component(s) 102 may be provided in the form of, for example, a pool component, pool equipment, a sensor, a valve, a pump having a variable frequency drive (VFD) or variable speed drive (VSD), a monitoring device or detector, various communication enabling devices, and/or other electrically controllable pool or spa related devices or components.

Each system component 102 may be connected to the other system components and to the network 108 via the root node 104. The system components 102 may be controlled by the root node 104, the user device 106, other system components 102, or a combination thereof. The connected system 100 is designed to provide monitoring and control of the system components 10,2 and the system components 102 communicate the monitored information to initiate system updates efficiently to one or more of the system components 102 of the connected system 100.

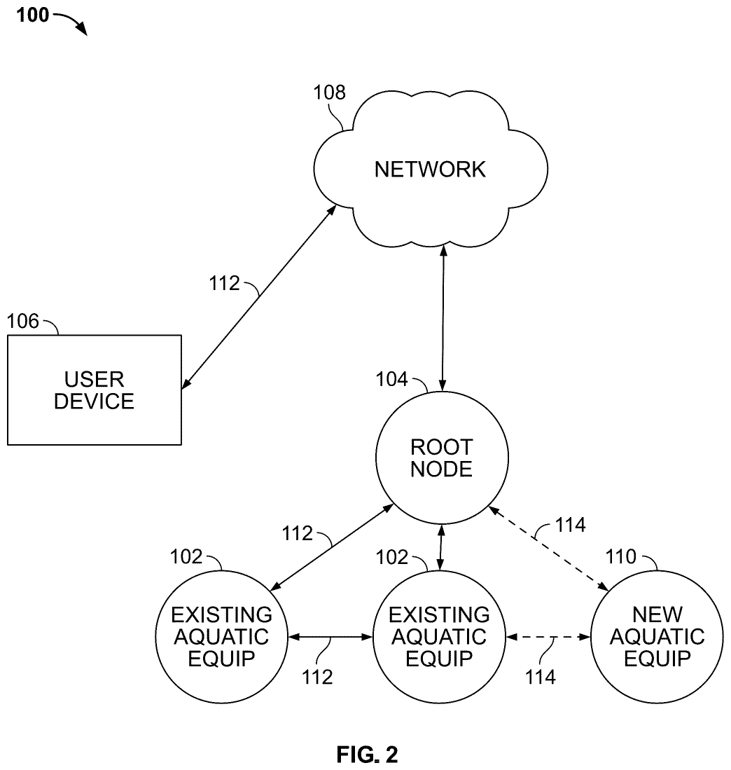

As shown in FIG. 2, the connected system 100 is provided in the form of multiple aquatic system components 102 that are in communication with one another in addition to being connected to the overall connected system 100. In at least this embodiment, the connected system 100 is designed to provide updates via update communication module connections 112 to existing system components 102, wherein the existing system components 102 include the system components 102 that are already connected to the connected system 100. Furthermore, the connected system 100 may include one or more configuration communication module connections 114 designed to connect and configure new system components 110, as described in more detail in connection with FIGS. 2 and 6-9. The connected system 100 connects the system components 102 and 110 to each other and to cloud-based backend network 108 via a root node 104, a central controller, or similar, to create a monitoring and communication system between system components that is adaptable, scalable, reliable, and can accommodate different users, devices, manufacturers, and system configurations. The connected system 100 may be used to automatically identify and configure the operating parameters and other baseline system component settings when a new system component 110 is introduced to the connected system 100.

The system components 102 are designed to communicate with other aspects of the connected system 100 to send and receive data sets and provide dynamic monitoring and control of various aspects of the connected system 100. When used throughout the present disclosure, it will be recognized that “data sets” can include, but are not limited to, one or more data elements, single variable data, data points, data tables, database(s), measurements, settings, configurations, parameters, commands, updates, topics, information, notifications, metrics, readings, similar data component, or any combination of these, or any other information or data, including data related to the overall connected system 100 and data related to existing system components 102 and new system components 110.

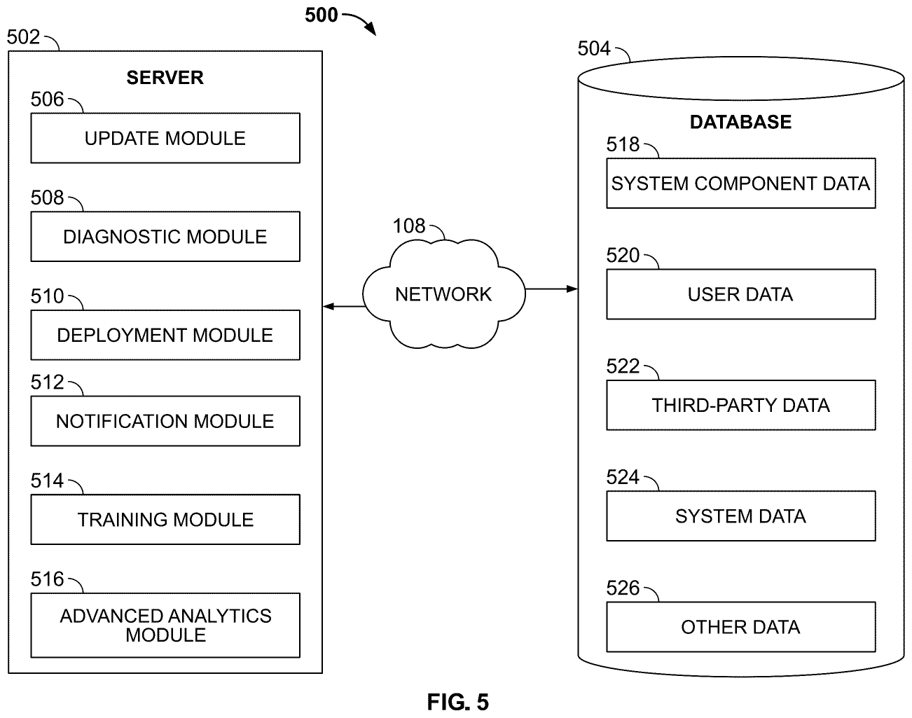

In some examples, the system components 102 may interface with the user device 106 either directly over a wired or wireless connection or a connection to the root node 104. The user device 106 may interface with the root node 104 either directly over a wired or wireless connection, or via a connection to the network 108. Similarly, the root node 104 may be provided in the form of a controller and in some examples can further include a control system 500 and processing system, as described with reference to FIG. 5. In some examples, the root node 104 interfaces with the control system 500 and processing system via a connection to the network 108 or a connection between one or more of the system components 102.

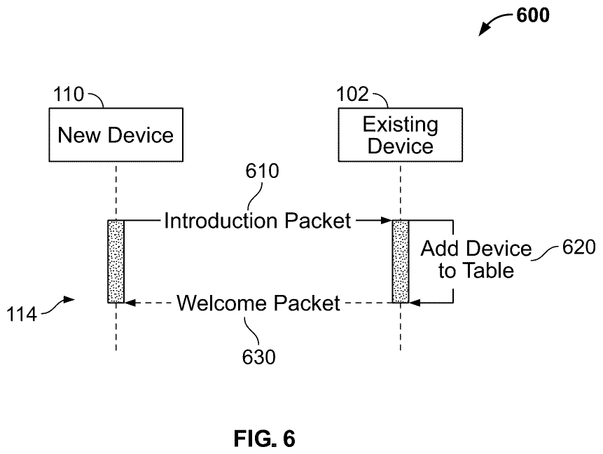

The system components 102 of the connected system 100 can communicate directly with one another using a network interface, local network, or other communication connection, and are not limited to the configuration communication module connections 112 and 114 shown in FIG. 2 and discussed in connection with FIGS. 6-9. In some examples, the configuration communication module connections 112 and 114 are provided in the form of a wireless module integrated with or coupled to the system components 102 and 110. A communication connection module can include, for example, a connection that can transmit and receive data using a communication protocol. Non-limiting examples of the communication protocol include: wired, wireless, Bluetooth, cellular, satellite, Global Positioning System (GPS), Global Navigation Satellite System (GNSS), RS-485, radio frequency (RF), MODBUS, Controller Area Network (CAN), CANBUS, DeviceNet, ControlNet, Ethernet TCP/IP, RS-232, Universal Serial Bus (USB), Firewire, Thread, proprietary protocol(s), or other communication protocol(s) as applicable.

The system components 102 and 110 can communicate without an Internet or network connection, allowing for future expansion and increased adaptability when adding and configuring new system components 110. The system components 102 may be removed or otherwise disconnected from the connected system 100, similarly allowing for the connected system 100 to automatically reconfigure the operating parameters of one or more system components 102 (e.g., the one or more system components 102 remaining in the connected system 100). The system components 102 can also communicate together wirelessly and complete configuration processes via a mobile application or other connected wireless devices. In some examples, the configuration communication module connections 112 and 114 can include unified messaging protocol(s) to allow for future expansion and increased adaptability when adding and configuring new system components 110. In some examples, the system components 102 and 110 can include a Wi-Fi module, or similar, to communicate data between the system components 102 wirelessly, even if there is no internet connection. The communication between the system components 102 can take place through a user's Wi-Fi router, or similar mesh system, using standard network protocols. In examples where the connected system 100 is a mesh-connected system 100, the mesh network configuration can allow for direct communication between the devices without an Internet connection and may allow for reduced traffic through a gateway while maintaining inter-device communication even if Internet access is interrupted. In some examples, a primary/secondary configuration can be used to designate specific communication devices for different roles in the mesh network.

The root node 104 can be provided in the form of a data aggregator to combine and process data from one or more of the system components 102 and 110. In some examples, the root node 104 also communicates with the network 108. In some examples, the network 108 is provided in the form of a scalable cloud-hosted backend.

In some examples, the root node 104 is provided in the form of a data-processing controller located proximate to the connected system 100 and designed to collect, transmit, and receive data from the system components 102 and 110. For example, in some examples, the root node 104 can act as a network interface to create a communication link that operatively connects the root node 104, the system components 102 and 110, and the user device 106 to the backend network 108. In another embodiment, the system components 102 can also act as a network interface and create a configuration communication module connection 112 and 114 directly to the other system components 102, 110, the root node 104, and the network 108. In some examples, the root node 104 is provided in the form of a data aggregator and operates in connection with a separate central controller device.

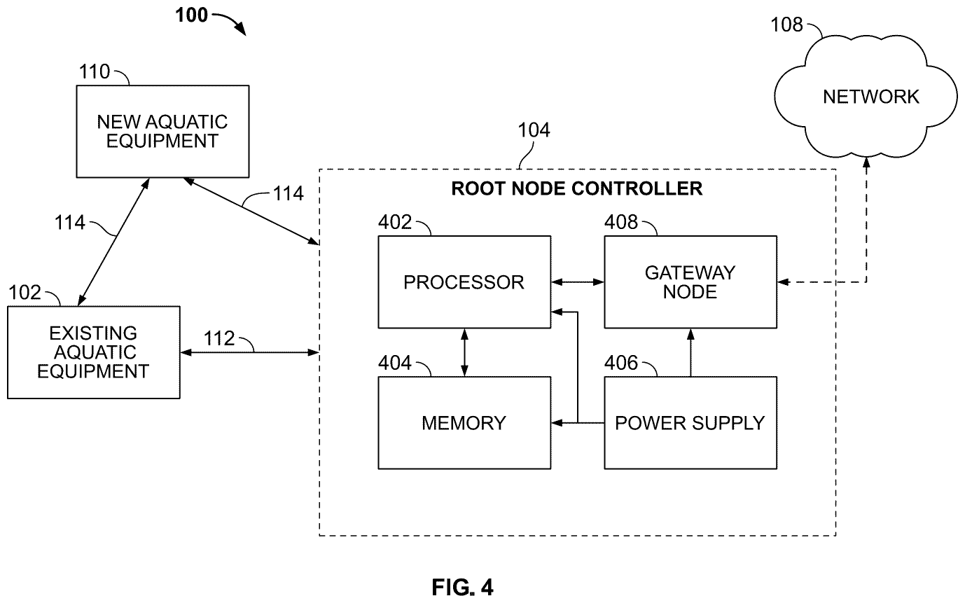

As described in more detail in connection with FIG. 4, the root node 104 may be provided in the form of a gateway, hub, switch, router, server, switch, or other connected device to allow integration, monitoring, and control of multiple aspects of the connected system 100. The individual system components 102 and 110 can monitor and control the other aspects of the connected system 100.

The root node 104 can receive data from the system components 102 and 110 via one or more configuration communication module connections 112 and 114, extract information from the data, aggregate the data, process the data, and store the data in a database 504 or lookup table of the connected system 100, as described in more detail in connection with FIGS. 4-5. The system can extract information from the lookup table data according to characteristics, parameters, settings, or similar configurations associated with a single data element or a particular system component 102 or 110. For example, a system component 102 or 110 can transmit the data set to the root node 104. The root node 104 can receive the data set and extract the data according to a characteristic, including but not limited to: sensor data, a timestamp for the sensor data, an identification element for the existing system component 102 and/or the new system component 110, user data 520 associated with the system component 102 (for example, user account, install date, geographic location, etc.), usage data, an error code, etc. The extracted data is transmitted from the root node 104 and stored in the database 504 or lookup table. In some examples, as described in connection with FIG. 4, the data set can be processed by the database, one or more processors, or other components.

A user can access data from the connected system 100 stored in the database 504 or lookup table. In one embodiment, the user can request customized reports with data from the connected system 100 and from individual system components 102. As a non-limiting example, the user can request a usage report containing runtime and power consumption for a specific system component 102 associated with the user's connected system 100. The user can also request recommended system configuration updates, which can be implemented automatically or updated manually by the user. For example, the system configuration updates can include a schedule or setting updates for an existing system component 102 runtime or downtime. In another example, the user can request a maintenance report including recommended maintenance procedures, timelines, and parts needed to fulfill a manufacturer's recommended maintenance procedures for one or more existing system components 102 of the user's connected system 100. The data from the connected system 100, including but not limited to sensor data described in connected with FIG. 3, can also be accessed using the user device 106.

The user device 106 can be provided in the form of any device capable of connecting to the Internet. In various examples, the user device 106 may be a portable device like a smartphone or tablet, a computer, or another display interface. In some examples, the user device 106 can include or is otherwise connected to, one or more programmable processors 402, a network interface, data capture elements, and a one or more memory units 404 (see FIG. 4). In some examples, the data capture elements can include a microphone, a camera, a vibration sensor, other types of sensors, or any combination thereof. The user device 106 can include a Wi-Fi, Bluetooth, cellular, or similar wired or wireless device that can support a communication link such as communication module 112 used to communicate with the network 108. Furthermore, in some examples, the user device 106 can include program instructions that are stored on a non-transitory computer-readable medium of the user device 106 and can be executed by the one or more programmable processors 402 to perform the processes described herein.

In one embodiment, a user can install an application on the user device 106 or on another portable device or display interface to access data associated with a user account. The user can set up a user account when the user registers or installs a connected system 100 or a new system component 110. When a new system component 110 is identified by the connected system 100, or added by the user, the system component 102 may be associated with the user account. The user can further configure other aspects of the connected system 100 to be associated with the given user account to send and receive data associated with the user's specific system components 102. The user account can contain personal information including user data 520 processed by the connected system 100 as information extracted from a data set, as described in more detail in connection with FIG. 5. It will be understood that “account” can also mean a record, a profile, or the like.

A user can register an existing system component 102 or a new system component 110 to be associated with the user account. In one example, the user (for example, homeowner, pool or spa owner, manufacturer, dealer, installer, and the like) can enter information about the system component 102 at the time of installation, or anytime thereafter, such as the manufacturer or other system component data 518 (see FIG. 5). When used throughout the disclosure, “dealer” can include, but is not limited to, a third-party capable of providing service, parts, and technician(s) to assist a user in the repair or replacement of system components 102, installation of a new system component 110, or routine maintenance. In some examples, the user may scan a receipt, barcode, Quick Response (QR) code, Radio Frequency Identification (RFID) tag, serial number, or another identification element on the system component 102 or the packaging to register the system components 102, 110 with a user account. In one embodiment, the system component identification element and associated system component data 518 is extracted and stored in the database 504 or lookup table, as described in more detail in connection with FIGS. 5 and 6.

As described in more detail below, the information extracted when a new system component 110 is introduced to the connected system 100 can be used to provide analytic information to the connected system 100 and authorized third-party systems. The extracted information can be used to assess the overall performance of the connected system 100 and individual system components 102. The extracted information can be analyzed with the operating parameters of the existing system components 102 to provide datasets to the new system component 110, recommend corrective action, and implement system updates to improve overall system performance and reduce inefficiencies of the connected system 100.

The overall system performance and inefficiencies can be determined or evaluated based on several non-limiting factors, including system component type and size (for example, flow, speed, BTU size, chlorine output, etc.), energy usage (for example, average based on user's zip code or utility provider), pool size, pipe size and type, system performance metrics (for example, pressure, flow, filter media, etc.), seasonal weather data (for example, water temperature, air temperature, rain, wind, etc.), the number of skimmers (or other system components like those described in connection with FIG. 3), the filter model/type, and the like.

The user device 106 can be connected to the existing system components 102 and the root node 104 to receive alerts or notifications related to the operation, functionality, and maintenance of the system components 102. The user device 106 can also be used to send information to the control system 500 or authorized third parties via the network 108 to assist in diagnostics, in one example.

In some examples, the network 108 is located proximate to the system components 102. The network 108 includes, for example, the Internet, intranets, extranets, wide area networks (WANs), local area networks (LANs), wired networks, wireless networks, cloud networks, or other suitable networks, or any combination of two or more such networks. For example, such networks can include satellite networks, cable networks, Ethernet networks, and other types of networks. In one embodiment, the network 108 is an isolated private network utilizing a private Internet Protocol (IP) address and limiting access to the network 108. In some examples, the network 108 can include one or more computing devices that can be arranged, for example, in one or more server banks or computer banks, or other arrangements. Information related to the network 108, including connectivity status, speed, security, connected devices, wireless interface, etc. can be communicated to other aspects of the connected system 100 as a data set, as described in more detail in connection with FIG. 5.

FIG. 3 depicts an example of the system components 102 that illustrate an example aspect of a connected aquatic monitoring system according to disclosed examples. When used throughout the disclosure, the system components 102 described in connection with FIG. 3 can include one or more of the new system components 110 introduced into the connected system. In certain instances, the aquatic application may be provided in the form of a spa and include components designed for use with a spa. In other instances, the aquatic application may be provided in the form of a pool and a spa and include components that may be used with a pool and spa system. In yet other instances, the aquatic application may be provided in the form of pool and/or spa components designed for use with a pool and/or a spa in a residential setting or a commercial setting.

The system components 102 may be provided in communication with each other and the pool or spa to form a fluid circuit. The fluid circuit facilitates water movement from the pool or spa through the system components 102 to accomplish various tasks including, for example, pumping, cleaning, heating, sanitizing, lighting, and similar. Additional arrangements of the connected system 100 besides those shown in FIGS. 1-3 are also contemplated.

As seen in FIG. 3, the system components 102 can include one or more of the following devices utilized for operating and maintaining a residential aquatic system like a pool or spa: a pool pump 302, a booster pump 304, one or more filters 306, a solar controller 308, one or more solar panels 310, one or more heaters 312, one or more sanitizers 314, a water quality monitor 316, a pH regulator 318, a water feature 320, a pool cleaner 322, a pool skimmer 324, a pool drain 326, a pool light 328, a salt chlorine generator 334, and other equipment 330. In some examples, more than one of each type of the system components may be included. The system components 102 can further include one or more valves 332 to control the individual system components 102. The valves 332 can be controlled manually or remotely via the user device 106, the root node 104, individual system components 102, or any combination thereof.

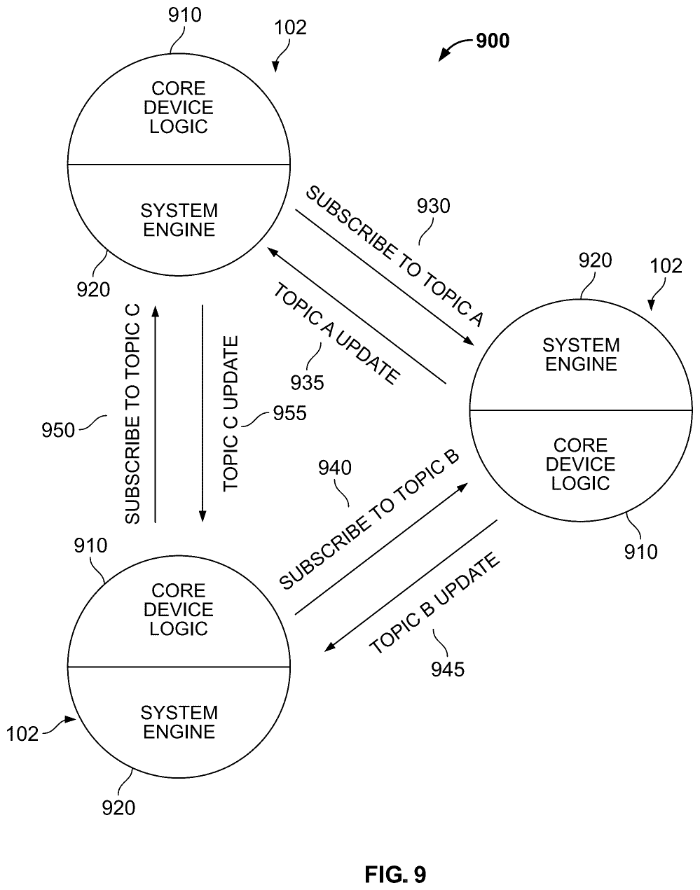

Each of the system components 102 can include an identification element, which can include information about the type of system component 102 (for example, device type) and other features, settings, options, parameters, characteristics, or distinguishing aspects of the device. The identification element can be assigned by a manufacturer, by the user, or by a system engine 920 (see FIG. 9) of the system component 102. The identification element can further include a product serial number, be assigned when a user registers the component, or otherwise be associated with a specific user account after installation.

Each of the system components 102 can further include a sensing device. The sensing device can be provided in the form of an integrated sensor, an external sensor, a sensing unit coupled to or in communication with the system component 102, or a combination thereof. It will be understood by those having skill in the art that the term “sensing device” as used throughout the specification can include several different sensing devices, sensing device configurations, or other monitoring or measuring devices. This can include a sensor unit with an individual sensor, a sensor unit with multiple sensors, a single sensor with multiple sensing capabilities, or a combination thereof.

In various examples, a sensing device integrated with or removably attached to the system components 102 is designed to monitor one or more operating parameters of the system components 102. Multiple sensing devices can be installed based on the size, specifications, and complexity of the connected system 100 to collect accurate information. The sensing device may be provided in the form of one or more of a power sensor, a temperature sensor, a pressure sensor, a gyroscope, an accelerometer, a vibration sensor, a flow sensor, a current sensor, a voltage sensor, a power sensor, a frequency sensor, an energy sensor, a fault sensor, an audio sensor, an optic sensor, a piezoelectric sensor, a capacitance sensor, or a combination thereof. In some examples, the sensing device may include more than one of a particular type of sensor. Moreover, the sensing device can be connected to, and designed to collect data from, one or more of the system components 102. In this non-limiting example, the sensing device can further include different types of sensing components to collect and extract information related to the operating parameters and send the data set to the root node 104 or another system component 102 via a wireless or wired connection. In some examples, the sensing device can be at a different geographic location than the root node 104.

Each of the system components 102 can collect, send, and receive data sets to and from the other system components 102 or via the root node 104. The data sets collected and sent from the system components 102 can include, at least, specific component information from the manufacturer for the system component 102 and operating parameters. As described above, this can include information entered either directly or indirectly from the user, but can also include information from the manufacturer, such as routine maintenance schedules, system updates, or subscription settings. The data sets collected and sent via the system components 102 can further include operating parameters collected from the sensing device(s) associated with and connected to each of the system components 102.

The system components 102 shown in FIG. 3 can include an integrated sensing device or an external sensing device for collecting and extracting data sets associated with the identification element and operating parameters for the system component 102. Non-limiting examples of the system components 102 and the extracted data are described herein, but additional system components 102 and operating parameters are contemplated herein.

As a non-limiting example, the pool pump 302 and booster pump 304 can include one or more sensing devices designed to detect power, vibration, current, flow, pressure, temperature, frequency, or a combination thereof. The power sensor can measure when the pool pump 302 and booster pump 304 are connected to power, and whether the pump(s) are activated. Additionally, some pool pumps 302 and booster pumps 304 have a soft start mode or similar controlled or reduced power mode, which can be measured and detected by the power sensor. The vibration sensor can measure vibration levels to identify electromagnetic or mechanical imbalance, loose components, rubbing parts, part failure, cavitation, or resonance. Some examples can further include an accelerometer to detect if the device becomes unlevel or sustains an impact force. The current sensor can measure the current flowing through the pump(s) using a non-intrusive method. The flow sensor can measure the flow of water that is pumped by a motor of the pool pump 302 and the booster pump 304 and determine the actual health of the motor by determining if the flow rate is unexpectedly high or low based on the particular application and various threshold metrics. The flow sensor can also include a flow switch or a fluid velocity sensor to detect abnormal flow rates. The pressure sensor can monitor the pressure in air compressors, heat exchangers, and similar that all use pumps to push air or water through their respective systems. The pressure sensor can further measure an input and differential pressure at the head of the pool pump 302 or the booster pump 304. The sensing device can be designed to overcome the faults and monitor the pool pump 302 and booster pump 304. Further, the temperature sensor may monitor the temperature and help to detect any abnormal temperature rise or fall due to any malfunction or failure, this can include but is not limited to temperature measurements at the inlet, outlet, and motor. The frequency sensor can measure the frequency of the pool pump 302 and the booster pump 304 and can be used for controlling Variable Frequency Drives (VFDs) that can be associated with or connected to either the pool pump 302 or the booster pump 304. In some examples, an encoder can be used to measure and monitor the velocity of a rotor/impeller of the pool pump 302 and the booster pump 304. Other sensing devices, such as the voltage sensor, can monitor the input voltage and calculate the power factor of a motor of the pool pump 302 and the booster pump 304 using both current and voltage values of the connected system 100 or the values detected by the sensing devices connected to each of the pool pump 302 and the booster pump 304.

In another non-limiting example, the filter 306 can include a sensing device designed to detect: pressure, flow, fluid velocity, or a combination thereof. The pressure sensor can detect and monitor differential pressure to identify when the filter 306 can be dirty or clogged with debris. Routine maintenance alerts can be provided to regularly clean the filter 306 and extend the life of the filter 306. The flow sensor can include a flow switch or a fluid velocity sensor to measure the flow status and flow rate at the inlet, outlet, and backwash ports of the filter 306. Additionally, the flow sensor can measure the flow rate to help detect potential leaks in the filter 306 and a filter compartment that houses the filter 306.

In another non-limiting example, the solar controller 308 can include a sensing device designed to detect: power, voltage, current, temperature, or a combination thereof. The power sensor can determine when the solar controller 308 is connected to power, and whether it is activated. The voltage sensor can monitor the input voltage and detect any upstream electrical system faults. The voltage sensor can also measure the control voltage and verify the output signal to a solar valve actuator is within range (for example, ˜0-24V), and can verify the solar controller 308 relay voltage is within range (for example, ˜0-230 VAC). In other examples, other ranges may be used. The temperature sensor can be used to monitor an internal temperature of the solar controller 308 and identify if any internal components, including electronic components, are overheating.

In another non-limiting example, the solar panels 310 can include a sensing device designed to detect: power, voltage, current, solar radiation, or a combination thereof. The power sensor can measure when the solar panels 310 are activated. The voltage and current sensors can be used to detect power generation and the power output of the solar panels 310. In addition to the data analytics techniques described herein, the data collected by the sensing device(s) can be used to produce energy reports and historical usage data displayed on the user device 106. The data can also be used by the other system components 102 to evaluate performance and propose updates. A photosensor can be used to detect levels of solar radiation (for example, the photosensor may determine if it is a sunny day or a cloudy day).

In another non-limiting example, the heater 312 can include a sensing device designed to detect: power, voltage, current, temperature, pressure, or a combination thereof. The power sensor can measure when the heater 312 is connected to power, and whether it is activated. The voltage sensor can monitor the input voltage and detect any upstream electrical system faults. The voltage sensor can also measure voltage drop to determine the power consumption of the heater 312. The current sensor can detect potential shorts in the heater 312 by identifying abnormal power consumption or current spikes. The temperature sensor can be used to monitor the internal temperature of the heater 312 including the heating elements. The temperature sensor can also measure the temperature at an inlet and an outlet to verify the water temperature is being heated according to the heater 312 controls and settings. The pressure sensor can measure differential pressure between different system components 102 to identify scale accumulation or fouling of a water passage in the heater 312.

In another non-limiting example, the water quality monitor 316 can include a sensing device designed to detect: power, voltage, flow, resistance, water chemistry, or a combination thereof. The power sensor can measure when the water quality monitor 316 is connected to power, and whether it is activated. The voltage sensor can monitor the input voltage and detect any upstream electrical system faults. The voltage sensor can also measure a battery level if the water quality monitor 316 is battery-powered or includes a battery pack. The flow sensor can also include a flow switch and can monitor water flow at an input and an output of the water quality monitor 316 and can identify potential clogs in the monitoring system. The flow sensor can further determine if the flow velocity is sufficient for proper operating conditions for the water quality monitor 316.

In another non-limiting example, the sanitizer 314 can include a sensing device designed to detect: power, radiant energy, resistance, voltage, current, pressure, or a combination thereof. The power sensor can measure when the sanitizer 314 is connected to power, and whether it is activated. In some examples, the sanitizer 314 is an Ultraviolet (UV) Light sanitizing device and a photosensor can be used to measure the radiant energy of the sanitizer 314 to also determine if the sanitizer 314 is activated. The resistance sensor can determine the electrical resistance across the UV bulb to verify the bulb is properly installed and within a functional range. Irregular resistance measurements can indicate a replacement bulb is needed for the sanitizer 314. The voltage sensor can monitor an input voltage and detect any upstream electrical system faults. The voltage sensor can also measure voltage drop to determine the power consumption of the sanitizer 314. The current sensor can measure the current in the sanitizer 314 system to verify the circuit is working properly. Low or non-existent current measurements can indicate that a replacement bulb is needed for the sanitizer 314. The pressure sensor may measure differential pressure to detect scale or fouling through a water passage in the sanitizer 314.

In another non-limiting example, the pH regulator 318 can include a sensing device designed to detect: power, voltage, current, level, chemistry, flow, or a combination thereof. The power sensor can measure when the pH regulator 318 is connected to power, and whether it is activated. The voltage sensor can monitor the input voltage and detect any upstream electrical system faults. The current sensor can measure the current in the pH regulator 318 system to verify that the circuit is working properly. Abnormal current measurements or an abnormal power consumption reading can indicate a malfunction. A chemical tank level associated with the pH regulator 318 can be measured by a level sensor, such as but not limited to: a float switch, force sensor, or similar. The chemical sensor can be used to identify chemical properties within the chemical tank. In some examples, one or more electrodes, or similar, can be used to measure a difference in the electrical potential between a pH electrode and a reference electrode. The flow sensor can include a flow switch or a fluid velocity sensor to measure the rate at which chemicals are dispensed through the pH regulator 318 system. In some examples, the flow sensor can also be integrated with, or otherwise communicate with, the chemical sensor to measure the type and quantity of chemical(s) dispensed. In some examples, an encoder can be used to measure, monitor, or detect the rotational position and velocity of a dispensing component of the pH regulator 318.

In another non-limiting example, the water feature 320 can include a sensing device designed to detect: power, flow, pressure, or a combination thereof. The power sensor can measure when the water feature 320 is connected to power, and whether it is activated. The flow sensor can include a flow switch or fluid velocity sensor, or similar, to measure the flow rate through the water feature 320. The pressure sensor can be used to detect a water depth at a bottom surface of the water feature 320. The pressure sensor can also communicate with the flow sensor to measure the flow rate through the water feature 320.

In another non-limiting example, the pool cleaner 322 can include a sensing device designed to detect: power, voltage, pressure, or a combination thereof. The sensing device can also determine if debris should be emptied from the cleaner. The power sensor can measure when the pool cleaner 322 is connected to power, and whether it is activated. The voltage sensor can monitor the input voltage and detect any upstream electrical system faults. The pressure sensor can measure a suction level in a suction line of the pool cleaner 322. An encoder can be used to detect whether one or more spinning motors of the pool cleaner 322 are rotating properly. As with the other system components 102 described herein, the monitored measurements can vary depending on the manufacturer and type of pool cleaner 322.

In another non-limiting example, the pool skimmer 324 can include a sensing device designed to detect pressure. A differential pressure sensor can detect if there is a clog in a skimmer basket of the pool skimmer 324 or if debris is interfering with air being induced in an equalizer line of the pool skimmer 324. In some examples, an encoder can be used to detect a position of a weir installed in the pool skimmer 324.

In another non-limiting example, the pool drain 326 can include a sensing device designed to detect: temperature, flow, pressure, or a combination thereof. The temperature sensor can measure the temperature of the water output flowing through the pool drain 326. The flow sensor can include a flow switch or fluid velocity sensor, or similar, to measure the flow rate of water through the pool drain 326. The pressure sensor can measure a pool water level. The pressure sensor can also measure a differential pressure to detect if the pool drain 326 may be clogged.

In another non-limiting example, the pool light 328 can include a sensing device designed to detect one or more of power, voltage, current, resistance, ambient light, or a combination thereof. The power sensor can measure when the pool light 328 is connected to power, and whether it is activated. The voltage sensor can measure the input voltage to the pool light 328 and detect any upstream electrical system faults. The current sensor can measure the current through the pool light 328 and can be used with the voltage sensor to measure power consumption. The voltage sensor or the current sensor can also detect when there is an abnormal power consumption measurement, which can indicate a malfunction with the pool light 328. The ambient light sensor may detect a brightness level of the area surrounding the pool or spa and may send one or more signals to the pool light 328 to turn on when the ambient light drops below an ambient light threshold. In some examples, the pool light 328 can include multiple pool lights and can also include advanced lighting controls such as animation, color, dimming, timer controls, etc. The advanced lighting control features for the pool light 328 can include a sensing device to detect and measure system variables or other operating parameters associated with the one or more lighting control features. In some examples, the resistance can also be measured to identify electrical shorts, faults, or when a light bulb or diode needs to be replaced.

In another non-limiting example, the valve(s) can include a sensing device designed to detect: voltage, current, position, flow, or a combination thereof. The voltage sensor can monitor the input voltage and detect any upstream electrical system faults. The voltage sensor can also measure the control voltage and verify the output signal to a valve actuator is within range (for example, ˜0-24V). In other examples, other ranges may be used. The current sensor can measure the current in the valve system and detect if there is an abnormal current measurement. Abnormal current measurements or an abnormal power consumption reading can indicate a malfunction in the valve(s). The position of a valve actuator or shaft can be detected using a position sensor, encoder, or similar. The flow switch can measure the flow rate through the valve(s) and detect if a valve port is not receiving an expected flow.

In another non-limiting example, the other equipment 330 can include a sensing device designed to detect operating parameters associated with components of the other equipment 330 (for example, power status, operational mode, flow, pressure, chemical composition, calibration status, and other parameters).

In one embodiment, the sensing device (for example, any of the sensing components, sensors, or other monitoring devices discussed above) can send data sets associated with the operating parameters and historical data of the system components 102 continuously, at scheduled intervals, or in response to a request or other system event. In this example, the request or system event can include user input received by the user's device. For example, if a user wanted to check the temperature of the pool or spa, the user device 106 could receive this request and transmit a command to a sensor, in communication with the pool or spa water, to collect the current temperature reading and transmit the information back to the user device 106 and process the data sets to generate a display to be displayed on the user device 106.

FIG. 4 illustrates a system view of one embodiment of the root node 104 in communication with one of the existing system components 102 and one of the new system components 110, to illustrate an example of a communication module in the connected system 100 operatively in communication with the root node 104. As described in connection with FIG. 3, the existing system component 102 and/or the new system component 110 can include an integrated sensing device or otherwise be connected to an external sensing device. The root node 104 can also, in certain examples, send and receive information, including information from the sensing device or other data relating to the system components 102 to the other system components 102 via the network 108, communication modules (for example, the update communication module 112, the configuration communication module connections 114, etc.), or other communication processes. In some examples, the root node 104 can further include aspects of a controller, including but not limited to one or more programmable processors 402, one or more memory units 404, a power supply 406, and a gateway node 408.

The one or more memory units 404 can be designed to store user record information or information received from the system components 102 and sensing devices. The one or more memory units 404 can be implemented as a stand-alone memory unit or as part of the one or more processors 402. The one or more memory units 404 may include one or more memory devices.

Furthermore, as one non-limiting alternative to the configuration seen in FIG. 4, the network 108 can include one or more programmable processors or a network interface and can be electronically coupled to a memory or database device. In some examples, the network 108 can include program instructions that are stored on a cloud server non-transitory computer-readable medium and are executable by the programmable processor 402 or other programmable processors to perform one or more of the processes described herein. In some examples, the one or more processors 402, one or more gateway nodes 408, one or more memory units 404, one or more power supplies 406, and similar processing components can be integrated into a central controller that communicatively operates with the root node 104 to accomplish the processing and data aggregation tasks of the connected system 100.

In a non-limiting example, the one or more programmable processors 402 can include one or more lookup modules provided in the form of hardware, firmware, software, or a combination thereof. The lookup module(s) can include a controller for executing program instructions. The lookup modules can include, in a non-limiting example, a status lookup module, a parameter lookup module, an update module 506, and an output lookup module.

For instance, the lookup modules can be executed by the one or more processors 402, the root node 104, the system engine 920 (see FIG. 9) of a system component 102, or a combination thereof. The status lookup module can be designed to determine the status of a system component 102 and determine when an operating parameter has changed. The status of a system component 102 can include: installed, powered on, powered off, connected, disconnected, offline, online, error, or any combination thereof or similar status. The status determined by the status lookup module can be passed to the parameter lookup module, the update module 506, and the output lookup module. The parameter lookup module, the update module 506, and the output lookup module can use the received status to access stored operating parameters.

Stored operating parameters can be stored on a non-transitory computer-readable medium, such as the one or more memory units 404 that is functionally a part of the root node 104, the database 504, or other processing systems. Stored operating parameters can be in the form of one or more lookup tables or one or more databases 504 that use the determined status to determine whether to automatically configure a system component 102 and the associated connected system components 102 when a new system component 110 is added or removed. Stored operating parameters can include, but are not limited to, user settings, manufacturer-recommended settings, schedule settings, past usage data, local trend data, etc. to update one or more of the system components 102 of the connected system 100 when a new system component 110 is added to the system, when a device is removed, or when the status lookup module otherwise indicates that the status of one or more components has changed or there is an update to one or more of the system components 102. In some examples, the local trend data may include one or more of pool size and volume, installation standards, builders, manufacturers, configurations, usage, weather trends, etc. related to the geographic location of the installed connected system 100. In some examples, the local trend data can be evaluated based on a user's zip code or the location sensed from one or more user devices 106.

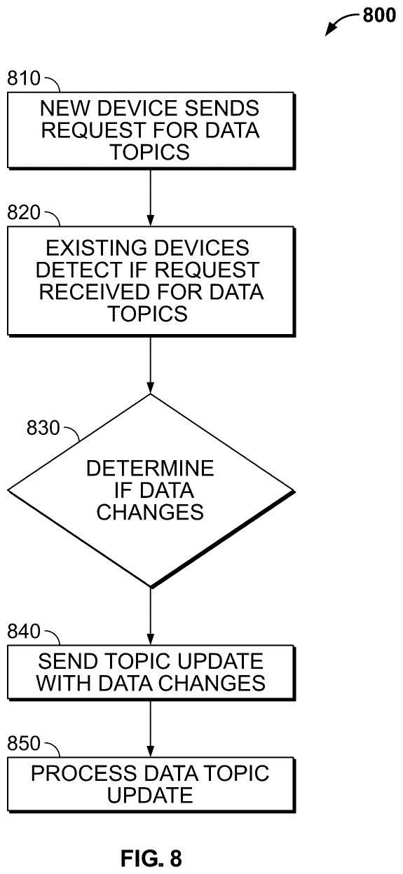

The update module 506 can be designed to communicate with the advanced analytics module 516 or other processing modules to determine if updated operating parameters are recommended as a result of connected system analytics or the output of the iteratively trained training module. As described in connection with FIGS. 8 and 9, the update module 506 can monitor for updates associated with one more data sets related to a system component, initiate and update process to communicate the updates to the one or more system components 102 that are subscribed to the updates associated with the one or more data sets for a particular system component, and generate an updated data set or other notification.

In another embodiment, the update module 506 can also include manufacturer-recommended updates or updates based on other external systems. For example, if the root node 104 is designed to receive weather prediction information via the network 108, the update module 506 can receive and process this information, and push a recommended update to the connected system 100 to modify the pool heater 312 settings, to accommodate the weather forecast while maintaining the user's pool temperature preferences, while minimizing the demand output and energy usage of the pool heater 312 or other system components 102.

The output lookup module can be designed to store the real-time operating parameters detected by the one or more sensing devices associated with each system component 102. In one embodiment, this collected usage data can be stored in the database 504 and retrieved by the output lookup module to generate one or more input data sets for the iteratively trained training module. In some examples, the output lookup module can be used as a feedback loop, or in connection with a feedback module for the iteratively trained training module to improve the overall performance of the connected system 100 and improve the accuracy of the advanced analytics module 516 and the iteratively trained training module.

FIG. 5 is a block diagram of a control system 500 of the connected system 100. The control system 500 can include a server 502, one or more databases 504, one or more programmable processors and memory units, and one or more network interfaces. In some examples, the database 504, server 502, or a combination thereof, can be incorporated into or otherwise communicatively coupled to the one or more system components 102, as part of the device system engine 920, as described in connection with FIG. 9. In some examples, one or more programmable processors and memory units can be integrated into one or more of the other control system components including but not limited to, the server 502, the network interface, and the device system engine 920. The network interface can include any of the network configurations described in connection with the network 108 in FIGS. 1 and 2.

While the system components 102 described include a server 502 and a network interface, the control system 500 configuration may include computing devices in various configurations. The computing elements of the control system 500 can be provided via one or more computing devices that can be arranged, for example, in one or more server banks or computer banks, or other arrangements. Such computing devices can be located in a single installation or can be distributed among many different geographical locations. For example, the control system 500 can include computing devices that together can include a hosted computing resource, a grid computing resource, or any other distributed computing arrangement. The computing devices can further include one or more routers. In some cases, the control system 500 can correspond to a dynamic computing resource where the allotted capacity of processing, bandwidth, storage, or other computing-related resources can vary over time.

In one embodiment, the control system 500 is designed to process data sets using data processing modules within the server 502, in one non-limiting example. The data processing modules can include an update module 506, a diagnostic module 508, a deployment module 510, a notification module 512, a training module 514, and an advanced analytics module 516. In some examples, the control system 500 can include additional modules for processing and analyzing different data elements and data sets and are not limited to the data processing modules shown in FIG. 5. In some examples, the server 502 may include fewer modules than those shown in FIG. 5. The control system 500 can include any suitable number of processing modules (including a single processing module) for executing or carrying out any of the processes discussed herein.

In some examples, the connected system 100 can collect and store data sets in the database 504, where the data sets can then be processed by the data processing modules to provide proposed corrective action to improve or maintain the performance of the connected system 100 using, in one example, advanced analytics and an iteratively trained training module. In some examples, the data sets can include one or more of system component data 518, user data 520, third-party data 522, system data 524, and other data 526.

In at least one example, the control system 500 receives transmitted data including system component data 518, which can include but is not limited to: manufacturer and manufacturer-provided information, model number, serial number, an identification element, a QR code, RFID tag, size or capacity, volume, parts list, coverage or protection information, installation information, configuration information, geographic location, date installed, recommended maintenance procedures and timelines, normal operating thresholds, and error/warning codes. In some examples, the control system 500 can obtain additional system component data 518 from the manufacturer of the system component 102 including maintenance procedure, maintenance timelines, tasks, rebates, recalls, common issues, or other data 526. The system component data 518 can further include the operating data obtained from the sensing device(s) described for the individual system components 102 in the description for FIGS. 1-3, although the system component 102 data is not limited to these examples. Additional system component data 518 can be collected, including, for example, service repairs, a maintenance history, usage data, and scheduled updates for a specific system component 102.

In some examples, the control system 500 receives transmitted data including user data 520, which can include but is not limited to: personal information about the user, contact information, address, a list or log of the user's specific system components 102, maintenance history information, secondary contact information, payment information, promotional codes, metrics regarding the use of the connected system 100, any notes regarding previous service requests (for example, gate access code, preferred service days/time, previous service technician notes, etc.), and other information. In one embodiment, the user data 520 can be updated to include notification settings, communication preferences, system component settings, historical usage data, programmed settings, schedule settings, or service information for a specific user, including call logs, diagnostic records, and service history. In some examples, the control system 500 can obtain additional information uploaded to the connected system 100 via the network 108, where the additional information can include, but is not limited to, photos and descriptions uploaded to the control system 500 to aid in diagnostics, service, or repair. In some examples, the diagnostic module 508 of the server 502 obtains access to information stored in the control system 500 to facilitate service.

In some examples, a third-party system can obtain access to the user-uploaded information stored in the control system 500 to facilitate service. In this example, additional authentication processes can be used before providing access to the third-party system. In some examples, a third-party system can transmit and upload information to the control system 500 to be associated with the user's specific system components 102, for example, photos after a service request is completed, notes from a technician, notes from a third-party regarding parts, a post-service summary report, a post-service survey, or other aspects of the service request. In some examples, the post-service summary report can be generated automatically by one or more processes described with the control system 500.

In some examples, the control system 500 receives transmitted data including third-party data 522, where the third party can be a dealer, pool servicer, or the like which can include but is not limited to: information about the third party, brands serviced, repair and service capabilities, profile information including descriptions regarding service and request handling techniques and priorities, invoicing and payment information, contact information, address, geographical regions located or serviced, a list or log of the third-party's specific system components 102 issues completed, maintenance history information, maintenance procedures and timelines, manufacturer information, part supply, number of available technicians, certifications, scores, and other information. In one embodiment, the third-party data 522 can be updated to include notification and communication preferences and settings and historical usage data for a specific user or servicer, or technician, including call logs, denied service requests, and service history. Third-party data 522 can further include information and operating parameters related to specific system components installed in connected systems of other users, which can be used by the connected system 100 to intelligently recommend updates to the system components 102 (for example, software patch update, setting configuration update resulting in average decline in energy usage, etc.).

In one embodiment, a third party can install an application on a device or otherwise integrate a third-party system with the control system 500. A third party can set up a record (for example, a dealer record) when the third party is an authorized servicer or dealer related to one or more of the system components 102. In some examples, the third-party data 522 can be updated in the control system 500 as the third-party updates the information in the third-party record. A user can also authorize one or more third parties to obtain access to some aspects of the user's account information stored in the control system 500.

In some examples, the control system 500 receives transmitted data including system data 524, which can include but is not limited to the status, health, and connection of the various aspects of the connected system 100, including the connectivity information between each of the system components 102 and the network interface(s). The system data 524 can include information related to the core device logic 910 of each system component 102, as described in more detail in connection with FIG. 9. The system data 524 can further include troubleshooting or general questions regarding the user or third-party interface, separate from the diagnostic aspects related to the system components 102. The system data 524 can further include information related to the status lookup module described in connection with FIG. 4.

In some examples, the control system 500 receives transmitted data including other data 526, which can include data sets not described in connection with the other transmitted data categories described. This includes, but is not limited to, historical information, usage reports, engagement information, parts supply, or any other data 526 that can be used by the control system 500 or other aspects of the connected system 100.

The control system 500 can utilize the processes illustrated in FIGS. 6-9 and described below to transform the data sets into customized outputs and proposed corrective action or other updates, in part, using advanced analytics, diagnostic tools, and an iteratively trained training module. The control system 500 can initiate and manage updates to one or more system components 102 using the update module 506 in connection with the other aspects of the connected system 100 described herein, where the updates can be related to a new system component 110 being added to the connected system 100, or when there is an updated operating parameter or similar of an existing system component 102.

The update module 506 is designed to receive and retrieve data sets from the existing system components 102 and any new system components 110. The update module 506 can include a list of devices, including the existing system components 102 of the connected system 100. As described in connection with FIGS. 8 and 9, the update module 506 can aggregate and organize the data sets and facilitate packets of data to be transmitted to one or more system components 102. In some examples, the update module 506 communicates with the notification module 512 to monitor when a request is received and the update module 506 communicates with the deployment module 510 to transmit the correct data packet corresponding to the request.

In some examples, each system component 102 includes an update module 506, deployment module 510, notification module 512, or a combination thereof. Each system component 102 is designed to monitor, process, and initiate data packets to/from other system components, in accordance with the processes described in more detail in connection with FIGS. 6-9. In at least this way, the connected system 100 includes an intelligently connected mesh network where system components 102 are designed to receive, process, manage, and distribute data directly to/from the other system components 102 of the connected system 100.

The diagnostic module 508 can be designed to receive and retrieve data sets from the sensing and monitoring devices of the connected system 100. The diagnostic module 508 is further designed to compare the data sets to pre-defined threshold values. In some examples, the data sets compared by the diagnostic module 508 include the system component data 518 and user data 520 but can include any datasets, or other combination of information, from one or more databases 504. The diagnostic module 508 can communicate with the sensing device(s) and the root node 104 to determine that a system component 102 is malfunctioning or has generated an error, warning, maintenance reminder, or similar. If an error code is detected, the relevant data sets can be transmitted to the control system 500 for additional analysis and processing. For example, the diagnostic module 508 can process sensor information indicating that a booster pump 304 is detecting abnormal pressure readings compared to the normal threshold values. In this example, the diagnostic module 508 can then compare other system component data 518 and determine that the filter 306 is processing an abnormally high number of debris, impacting the pressure in the overall connected system 100 and requiring an extended ramp-up time for the booster pump 304. The diagnostic module 508 can also include options to remotely troubleshoot system components, assist the user in self-diagnostics or self-repair, order replacement parts, or deploy a request to a third party utilizing the deployment module 510.

In some examples, the deployment module 510 can be designed for efficiently distributing requests to one or more system components 102 or to third parties. In another embodiment, the deployment module 510 can also be designed for pushing or installing updates to the system components 102 from other system components 102 or other aspects of the connected system 100. In some examples, pushing updates from one system component 102 to other system components 102 is completed automatically, although manual updates can also be configured using the system and processes described herein. In one embodiment, the deployment module 510 comprises one or more location monitoring components and parameter validators to compare the third-party data 522 to the diagnostic information generated by the control system 500 and the diagnostic module 508.

The notification module 512 can be designed for generating, creating, modifying, and logging events, system updates, component updates, schedule updates, etc. for the control system 500 and the connected system 100. The notification module 512 can also generate, update, and push notifications and customized alerts to one or more devices or applications for the user or a third party. In one embodiment, the notification module 512 is designed to be dynamic, scalable, and integrated with each system component 102, third-party systems, user devices 106, the user's other connected systems (for example, home automation, mobile applications, landscape systems, security systems, etc.), or a combination thereof. In some examples, the notification module 512 is designed to receive data sets from the data sources or applications and handle the notification generation and handling for the data sources and applications. In some examples, the notification module 512 can send and receive data packets from an existing system component 102 when a new system component 110 is connected to the system 100, as described in more detail in connection with FIG. 6

The training module 514 can be designed to perform various data analysis and modeling processes. In one example, the training module 514 generates and iteratively trains training modules for providing dynamic outputs. For example, in some examples the training module 514 can be designed to perform one or more of the various data processing, comparing, determining, and configuring steps of the processes shown and described in connection with FIGS. 6-9. The training module 514 can be designed to generate, train, and execute nodes, neural networks, gradient boosting algorithms, mutual information classifiers, random forest classifications, and other machine learning and artificial intelligence-related algorithms.

The advanced analytics module 516 can be designed to perform data processing techniques and steps, including but not limited to: report generation, troubleshooting help, customized user display content and recommendations, historical data, usage data, geographic trends based on zip code or other regional factors, weather pattern analysis, analytics based on received or retrieved third-party data 522, and other analytics. The advanced analytics module 516 can also be used for relationship handling processes including automated reminders, pushing system updates to the connected system 100 or system components 102, processing feedback, and other data 526 processing and data analytics tasks.

FIG. 6 illustrates a component configuration process 600 for adding a new system component 110 (for example, aquatic device) to the connected system 100 of existing system components 102. The new system component 110 is introduced to the mesh network of the connected system 100 and once adopted, the new system component 110 broadcasts, unicasts, or otherwise sends an “introduction packet” 610 to the existing system components 102 of the connected system 100. The introduction packet 610 can include data sets related to the new system component 110 including system component data 518. In some examples, the introduction packet 610 may be transmitted to only those existing system components 102 within a limited proximity to the new system component 110.

The existing system component 102 receives the introduction packet 610, processes the introduction packet 610, extracts system component data 518 regarding the new system component 110, and adds information associated with the new system component 110 to the lookup table 620 and to the update module 506. The lookup table 620 can include a list of existing system components 102 of the connected system 100, as well as information and data sets related to the system components 102. In some examples, the information and data sets received in the introduction packet 610 can be processed and stored by other aspects of the connected system 100.

The existing system component 102 transmits a “welcome packet” 630 including one or more data sets regarding the other existing system components 102 of the connected system 100. The welcome packet 630 further includes a list of all the connected existing system components 102 and can further include data sets related to each system component 102, in some examples. If multiple existing system components 102 receive the introduction packet 610, the existing system components 102 can use a configuration communication module connection 114, or similar, to coordinate or otherwise communicate which of the existing system components 102 will transmit the welcome packet 630 to the new system component 110. In at least this way, the connected system 100 utilizes one or more communication modules to efficiently allocate and use system resources. The one or more configuration communication module connections 114 can be used to execute one or more steps of the component configuration process 600 in order to connect and configure new system components 110 to the connected system 100. Other processes for allocating system resources and communicating directly between system components 102 are contemplated within the scope of the present disclosure.

The new system component 110 processes the welcome packet 630 and selects one or more system components 102 to “subscribe” to, which includes receiving one or more data sets associated with the system component 102. In some examples, the subscription includes topic updates, as described in more detail in connection with FIG. 9. The subscription selections made by the new system component 110 can be stored in the update module 506, communicated to the root node 104, stored on the local device, including the existing system components 102, or a combination thereof. When used throughout the present disclosure “topics” can include chemistry values, power status, temperature, water chemistry readings, flow rates, pH, and similar. Further, the topics and topic updates can be customized for the system component 102 generating the topic data set and for the specific system component 102 receiving the topic updates. In at least this way, the system can intelligently customize the data sets in one or more updates to improve performance of the individual system components and the overall system.

The component configuration process 600 for connecting and configuring new system components 110 can be repeated until all the new system components 110 are connected, configured, and updated accordingly as existing system components 102. In some examples, the connected system 100 can continuously, or at pre-defined intervals, or according to a schedule, monitor and provide updates to the subscription settings of existing system components 102 as changes and topic updates are detected throughout the connected system 100.

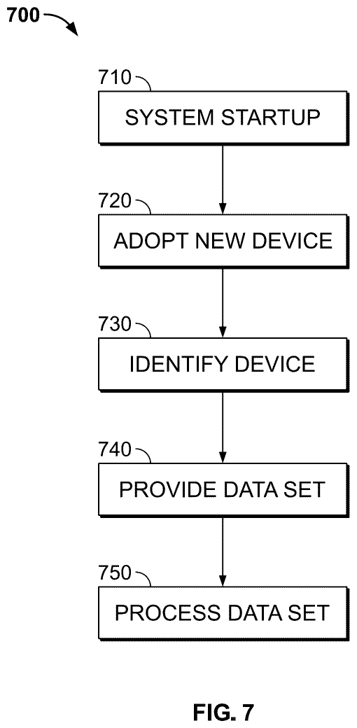

FIG. 7 illustrates a system component identification process 700 for identifying a new system component 110 (for example, aquatic device) to be added or connected to the connected system 100. At step 710, the connected system 100 can be turned on, or detected as already being powered on by a sensing device. In some examples, step 710 may be triggered by a new system component 110 in the proximity of the connected system 100 being started up, restarted, powered on, sending an introduction packet 610, etc. At step 720, the sensing device, root node 104, or an existing system component 102 can detect whether the new system component 110 is already configured or not otherwise connected to the connected system 100. In some examples, the new device adoption of step 720 includes the component configuration process 600.

In some examples, the connected system 100 may detect an existing system component 102 in step 720 after the system component 102 has been disconnected, disabled, powered down, or in error status for some period of time such that the existing system component 102 is not updated and is reconfigured as a new system component 110. In some examples, the new device adoption of step 720 may be triggered after a pre-defined amount of time an existing system component 102 is disconnected from the connected system 100. In some examples, one or more existing system components 102 can detect a new system component 110 and initiate the component configuration process 600 and the identification process 700. In some examples, one or more aspects of the connected system 100 can determine whether it is more efficient (for example, from a resource allocation standpoint) to reconfigure an existing system component 102 as a new system component 110 or update the device using an update module 506, deployment module 510, or similar.

At step 730, the identification element, described in connection with FIGS. 1-3, or the system component data 518 of the new system component 110, can be scanned, recognized, entered, or otherwise entered by the root node 104. In some examples, the identification step 730 can be performed by an existing system component 102 of the connected system 100. For example, if a connected system 100 receives an introduction packet 610 from a new system component 110 (for example, when a user is installing a new water feature 320), the pool light 328 system, or one of the individual pool lights 328 could detect and identify the water feature 320 component being added to the connected system 100 and add the water feature 320 to the lookup table 620 of existing system components 102 and transmit a welcome packet 630 to the water feature 320. In some examples, the welcome packet 630 is sent via the deployment module 510.

In step 740, the data set, including but not limited to the system component data 518, user data 520, third-party data 522, system data 524, and other data 526, described in connection FIG. 5, can be extracted from the new system component 110. In some examples, the data set may be stored separately from the local system component memory. In some examples, the connected system 100 can include an elastic cache, cloud storage, or other dynamic memory devices or systems to store and communicate data and data sets associated with the existing system components 102 connected to the system and new or reintroduced system components 110 during configuration and monitoring. At step 750, the data set can be stored in a system database 504 as described in connection with FIG. 5, or a lookup table 620, or other data storage device, component, system, or similar. At step 760, the data set can be processed by one or more of the processing modules on the server 502 (see FIG. 5). In some examples the data set may be processed by a processor or controller in the connected system 100, including but not limited to the root node 104 or a system engine 920 of an individual system component 102. In some examples, the data set may be transmitted to an external processor or processing system for processing. In some examples, the processing step of step 760 can include detecting or sensing operating parameters of the new system component 110. Operating parameters can include, but are not limited to, the operating data measured and described in connection with FIG. 3 and can be included in a data set. In some examples, the data sets measured by one or more of the sensing devices can be automatically and continuously transmitted to the control system 500 by one or more of the existing system components 102.

FIG. 8 illustrates an update process 800 for determining subscription settings for the new system component 110 and for existing system components 102 and deploying updates to the applicable system components 102. In one embodiment, the update process 800 may utilize the training module 514 described in connection with FIG. 5 to determine a subscription setting or operating parameter(s) for the one or more system components 102 to determine updates using an iteratively trained training module. At step 810, the connected system 100 can be turned on or detected as already being powered on by a sensing device. In some examples, step 810 may be triggered by the new system component 110 sending an introduction packet 610, being started up, restarted, powered on, etc. At step 810, the sensing device, the root node 104, or existing system components 102 can determine that the new system component 110 can select one or more data sets to subscribe to. In some examples, the new system component 110 can select an option to be updated based on specific data topics (for example, energy usage, runtime, maintenance, etc.), data types (for example, pressure readings, temperatures, power status, etc.), or all data sets associated with a specific existing system component 102 (for example, a new filter 306 could subscribe to all data sets associated with the pool pump 302).

At step 820 the system can identify a selection by the new system component 110 associated with a subscription request to an existing system component 102 and can notify the appropriate existing system component 102 via the notification module 512 or other communication connection module connections 112, 114. At step 820, the lookup table 620 can be updated to track and monitor the subscription list for all existing system components 102 of the connected system 100.

In step 830 the system can determine if one more data sets change. In some examples, the system components 102 and sensing device(s) can determine if an operating parameter changes, or other aspect of the data set is updated. Updates to the data set(s) can be stored in the update module 506. In some examples, the system components 102 can include an integrated update module 506 for monitoring and storing updates to the data set(s).

At step 840, if a dataset is determined to include an update, the deployment module 510, or other module of the connected system 100, can deploy updates, including topic updates to the system components 102 subscribed to the data set associated with the updates. At step 850, the subscribing system component can receive the data set(s) associated with the topic update and the updated data sets and process the updated data using one or more integrated processing modules or the processing modules described in connection with FIG. 5, or a combination thereof.

For example, if a new sanitizer 314 is added to the connected system 100 and configured in accordance with the component configuration process 600, the sanitizer 314 can select to subscribe to updates related to pH regulator 318 and the water quality monitor 316. The subscription selection is stored in a lookup table 620 and the deployment module 510 or the notification module 512 can notify the pH regulator 318 and water quality monitor 316 of the new subscription. Additionally, all existing system components 102 of the connected system 100 can be notified of the new sanitizer 314 and select to subscribe to updates related to data sets associated with the sanitizer 314. The subscription information for all system components 102 can be stored in the lookup table 620 and communicated to the system components 102 via other system components 102 directly or through the root node 104. If there an update to the water chemistry, as determined to by the water quality monitor 316, the updated data set is transmitted to the sanitizer 314 (and all other system components 102 subscribed to receive updates related to the water quality monitor 316 or to a water chemistry parameter) and the sanitizer 314 can process the updated data and automatically adjust operating parameters or configure component settings based on the updated data. This is a non-limiting illustrative example of the system and processes described herein.

As another non-limiting illustrative example, the connected system 100 can include a water chemistry sensing device with datasets related to pH, oxidation reduction potential (ORP), and temperature. The connected system 100 can further include a pump with datasets related to flow, speed, power, and a run schedule. A chlorinator of the connected system 100 is interested in both datasets provided by the chemistry sensing device and the pump, such that the chlorinator can adjust its output based on the pump runtime and the ORP of the water. The chlorinator could further use the pH level information to detect a change in pH over time and notify the user of a potential issue. In at least this way, the system and processed described herein provide an intelligently connected system that allows the individual devices to have individual control over the datasets subscribed to, the topic updates received, and the automatic configuration of operating parameters in response to the datasets received, or a portion thereof.

In some examples, topic updates may include the user's schedule and notification preferences, or other operating parameter settings or preferences associated with the user. In one non-limiting example, the user data 520 may include information relating to the user's tendency to turn on the spa heater on Friday around noon. The user data 520 extracted at startup can include the system component data 518 associated with the user indicating that the spa heater is activated and set to a particular temperature with consistent frequency. The system can be designed to determine, using an iteratively trained training module, in one example, that a user only heats the pool and uses the colored lighting system on holiday weekends, and the lights are set in a theme consistent with the specific holiday or season (for example, green for St. Patrick's Day, red, white, and blue for Memorial Day Weekend, rainbow for June, etc.).

FIG. 9 illustrates a subscription process 900 for sending, receiving, and processing updated data sets associated with one or more of the system components 102. Each of the system components 102 can include core device logic 910 and a system engine 920. The core device logic 910 can include the logic functions and processing modules used to receive, process, and manage data sets from the other system components 102. In one non-limiting embodiment, the core logic device 910 can include the logic functions built-in to the default configuration of the system components 102 (for example, pump logic, heater logic, logic-controlled valves, etc.). In some examples, the core device logic 910 can further include the update module 506, deployment module 510, and the notification module 512, as described in connection with FIGS. 5-8.

The system engine 920 can include one or more hardware or system components, including but not limited to those shown in FIG. 4 (for example, processor, memory unit, power supply, gateway node, and the like), as well as a communication module. In some examples, the system engine includes the logic for handling the subscriptions associated with the one or more system components 102. The core device logic 910 and the system engine 920 are not limited to those examples listed above and can include other logic functions and components.

The connected system 100 can be configured so that individual system components 102 are designed to process and manage data sets associated with the other system components 102 and automatically initiate updates among devices according to a subscription list. As shown in FIG. 9, the system components 102 can provide a selection to subscribe to a topic related to a data set associated with a specific system component 102 (as shown by 930, 945, and 950 in FIG. 9), and receive those updates and process those updates associated with the topics and data sets subscribed (as shown by 935, 945, and 955 in FIG. 9). In some forms, the connected system 100 is configured to provide a distributed update and subscription process rather than the subscription information being provided in a single centralized location.

In some examples, the connected system 100, or a system component 102, receives (or retrieves from one or more databases 504 or lookup tables or similar) a data set(s) including measured operating parameters that can be used to iteratively train one or more raw training modules to create trained training modules. In some examples, the system can input a data set (for example, extracted from the system component 102, stored in the database 504 or lookup table, or similar) as a training data set, or training data sets. The training data sets can be input into a raw training module based on the type of data or the data type associated with the data set(s). In one non-limiting example, this allows the system to iteratively train the training module(s) based on input training data sets of different data types and to provide corrective update recommendations based on the specific data type, on the user data 520, on the system component 102, on local trends or weather patterns, or based on any number of other factors or characteristics.

The training process can also include comparing the output of the raw training module to a known value(s), including subscription settings in some examples, for the input training data set. One or more nodal emphasis values of the system can be updated for nodes within the raw training module(s) based on the results of a comparing step, to iteratively train and improve the training module 514. In one embodiment, when the output of the raw training module(s) is within a preconfigured threshold of the known value(s) for the input training data sets, as determined during the comparing step, the raw training module(s) can be saved as the iteratively trained training modules.

The system can also be designed to receive and process an input data set associated with a specific system component 102. In one embodiment, a specific system component 102 can have multiple associated input data sets. In one embodiment, the system can input each of the input data sets through an iteratively trained training module based on the system component 102.

At step 830, the system or a system component 102 can be designed to receive operating parameter values as outputs from the comparing step 820 and input the operating parameters into the iteratively trained training modules and process the operating parameters in one or more of the processes described above. In at least this way, the system can utilize an iteratively trained training module to output specific corrective actions, including updated subscription settings, tailored to certain system components 102 of the connected system 100.

In some examples, the subscription setting update process at step 840 can include intelligent configuration updates based on the output of an iteratively trained training module. At step 840 the system can update the subscription settings according to the output of the training module 514 and store the updated subscription settings in a lookup table 620. In some examples, the updated subscription settings can then be used by the update module 506 and deployment module 510. In some examples, the system determines a proposed update based on the output of the iteratively trained training module and modifies a display or generates a custom notification based on the proposed update.

In some examples, the system can include one or more secondary metrics as operating parameters in the process of iteratively training one or more training modules 514. When used throughout the present disclosure, the processes for an “iteratively trained training module” can include machine learning processes, artificial intelligence processes, and other similar advanced machine learning processes. For example, the system and processes of the present disclosure can perform automatic configuration and re-configuration of system components, system or component updates, diagnostics, provide customized recommendations according to user data settings and preferences, generate custom reports, and similar processes. In some examples, the system can use additional inputs and feedback loops for an iterative training process.

In one instance, the data set processing can include using one or more training modules 514 to consider the recommended subscription settings not only based on the system component data 518 but also based on the operating parameters and configuration of the other connected system 100 aspects and other system components 102 of the connected system 100. For example, the system can monitor and detect head loss changes, monitor energy usage, temperature adjustments, etc., and provide proposed corrective action to update an operating schedule or other subscription setting modifications to improve the overall system performance by improving operating efficiency and minimizing energy usage where possible. In some examples, the proposed corrective action(s) can be provided in the form of a customized report generated for the user.

The subscription settings for the existing system component(s) 102 can be configured automatically using the root node 104, control system 500, update module 506, deployment module 510, or by directly communicating with the system component 102 and adjusting the subscription settings. The subscription settings for a system component 102 can be updated according to the recommended updates of the iteratively trained training module to improve overall system performance and the performance of individual system components 102. The new operating parameters of the system component(s) 102 can be monitored after the updated subscription settings are configured and additional updates can be performed or recommended, to further improve the performance of the connected system 100. As a non-limiting illustrative example, when a new pool light 328 is added to the connected system 100, via the component configuration process 600, as described above in connection with FIG. 6, the connected system 100 can update the subscription settings associated with solar controller 308, wherein the solar controller 308 can include an integrated photocell. The status of the photocell can provide an update to the data set (for example, low light levels trigger solar controller to power down for the evening), and send an associated topic update the pool light 328 to turn the light on in the evening.

In some examples, the connected system 100 can make informed decisions and customized recommendations based on the system components 102 configured in the connected system 100. In a non-limiting example, the system can make an informed decision that the pool pump output could be improved by using a small sand filter. This recommendation can be transmitted to the user via a notification system that indicates the connected system 100 may operate with better performance if a small sand filter is used as this could limit the pool pump output so that it is not overpowered and would lose filtration effectiveness because of “channeling”. In some examples, channeling can be an indication a pool pump 302 is too large for the filter 306 used or the filter 306 is overloaded by bather load (for example, bather waste and oils) or there is improper backwashing. Using information about all of the system components 102 on the pool pad, with additional information (for example, the user data 520), the total dynamic head (TDH) can be accurately estimated and used to further improve the performance of the system.

In some examples, the system can also include a user notification sequence process for generating notifications for one or more user devices 106. In one embodiment, the user notification sequence process can be used to generate notifications related to, but not limited to maintenance reminders, alerts regarding operating parameters of the system components, and other notifications.

In some examples, a customized output of the system can include lifestyle content and guidance can be provided by the processes and systems described herein (for example, pool party preparation, best practices for off-season pool care, etc.). In some examples, a video of the customized self-education library can be provided, such that maintenance reminders include written, video, or audio instructions or other tutorials to assist the user in self-repair or self-maintenance activities. The education library can be further customized for a particular user, a particular system component, or a geographic location where the equipment is installed.

It should be noted that while the systems and methods disclosed and described above with respect to FIGS. 6-9 are directed to detecting, identifying, and monitoring the system components 102 shown in FIG. 3, similar systems and methods are contemplated with respect to additional ones of the system components 102 of the connected system 100 as would be understood by those of ordinary skill in the art.

Additionally, the examples described herein are further directed to an improved system and methodology for automatically configuring system components 102 of a connected aquatic system to monitor the operating parameters and update the settings or operation of the system components 102 to improve overall system performance. These examples represent an advancement over the prior art for several reasons, including that the systems and methods are capable of automatically detecting, identifying, and configuring baseline systems without manual input by the user. Additionally, the examples can include a method and system for automatically detecting and updating operating parameters or baseline systems of individual system components 102 to not only improve the system component's operation but the overall system efficiency and performance. The examples can include measuring the operation and condition of components within a connected system 100, accumulating these measurements across a field of the connected system 100, performing statistical analysis on the accumulated measurements, performing advanced diagnostics, and producing one or more customized outputs.

In an embodiment, an integrated and advanced analytics system for processing, monitoring, and updating the operational state of system components 102 of the connected system 100 in a dependable, accurate, and efficient way is provided. The direct communication between each system component 102 provides real-time updates on a device-level subscription basis without a single central controller or a single point of control failure. Additionally, historical and geographic data (in addition to other statistical reporting capabilities) can be used to further improve data analysis and provide customized recommendations not only tailored to a specific user and connected system 100 but also based on general information for users with similar usage patterns or in geographically similar locations. Moreover, unexpected failures or unfavorable operating conditions can be mitigated, allowing for preventative maintenance, and aid in the diagnosis of faults. However, should sudden failures occur, the data obtained from the mesh connected monitoring system also allows for the efficient locating of faults so that remedial actions can be targeted, which again saves time and resources.

Even if the terms “value, parameter, location, component, device, unit, set, module, controller, server, measuring device, sensor, network” and similar, are used in the singular or in a specific numeral form in the claims and the specification the scope of the system should not be restricted to the singular or the specific numeral form.

The connected aquatic system includes devices or equipment that are designed to be used with the aquatic system and can be located in water during operation (for example, at least partially or entirely submerged) or on a pool pad or installed adjacent to the aquatic system. The system components, devices, or equipment can be used in any environment and can be embodied as an electrical connector or penetrator or advantageously as a wet connector/penetrator, or as a connector part. Moreover, the system components, devices, or equipment are advantageously employed in a high-voltage application, and also can be used in a medium or low-voltage application.

Furthermore, the operational parameter can include a physical parameter, like pressure, temperature, current, voltage, etc., and the operational value can include an absolute or differential measurement or number obtained for one parameter. The operational values as used herein refers to the similar parameters gathered or provided at different points in time. Moreover, a selected location should be understood as a location where condition monitoring is especially of interest or relevant.

Further still, a derivative as used herein means a result of an operation performed on the operational value(s). The derivative can be, for example, a specific difference between at least two values or a special gradient of several values, or a selected pattern of several values. In examples, the term “predefined” should be understood as “selected beforehand” and/or as “being saved in a control unit to be recalled for the comparison.” A reference as used herein can be any reference value or feasible values. The reference can be a single value or multiple values or a specific correlation of several values.

According to an embodiment, the reference defines an abnormal behavior of the device or a part thereof. As a result, unstable and critical conditions of the device can be identified, and suitable measures can be initiated to stop or undo the problem(s). Abnormal behavior as used herein means a condition where an action should be initiated to act on the system component 102 or its current operational state or when the operation of the system component 102 deviates from an acceptable, secure, or ideal operation.

In some examples, If the connected system 100 identifies the system component 102 is malfunctioning or operating outside of a predefined acceptable operational range, the system can communicate the monitored information related to maintenance, service, or other issues, initiate deployment of service requests and generate a user notification(s). In at least this way, the connected system 100 can provide advanced analytics for identifying overall system health and identify inefficiencies in the operating parameters of the system component 102 and facilitate an update to the configuration settings of the system component 102 to improve the performance of the overall connected system 100.

The system component 102 can also be removed, turned off, disabled, or similarly disconnected from the system component 102 for a fixed time period, or indefinitely. In this example, the connected system 100 can provide monitoring and control of the other aspects of the system components 102 and provide proposed corrective action to the operating parameters, as needed, to improve or maintain the performance of the connected system 100 when the system component 102 has been disconnected. In some examples, the data set(s) associated with the removed system component 102 may be stored, maintained, or similarly stored. In some examples, the data set(s) associated with the removed or disconnected system component 102 can be deleted, archived, or similar after a pre-defined amount of time or upon instruction by the user, third party, or similar.

In a further embodiment, the system activates at least one compensating action by the sensing device when abnormal behavior is detected in the system or portion thereof. In this context, a “compensating action” can include an action that alters the operating parameter(s) of the system component 102 or the connected system 100 or an aspect of the connected system 100 to correct the abnormal behavior and to mitigate potential damage to the underwater device or the system from the abnormal behavior. The compensating action can be any feasible action, like a de-energizing of the system component, an initiation of a tighter maintenance regime, activation of a maintenance action, especially a preventative maintenance action, or a reduction of a current level for the system component. The compensating action can be actuated or triggered by a device, hardware component, or manual action, like from a control system or a person monitoring a control system.

In some examples, the subscription settings for a system component 102 can be pre-configured by the factory, warehouse, manufacturer, dealer, or similar, based on the connected system 100 data collected and stored via a network 108.

In some examples, the data sets, including but not limited to the user data 520 and the system component data 518 can be tracked and stored using blockchain or a similar sequential system of recording data elements. In this example, the data sets and the processed data can be stored securely across a distributed network 108 and provide additional security features. In some examples, blockchain or similar technologies can store other information about the pool pad, including, for example, maintenance data and service life.

In one embodiment, each system component 102 can emit a signature radio frequency, which can be detected by the other system components 102, aspects of the connected system 100, or another connected device (for example, automation hub or similar). These signatures can be used, in some examples, to detect, identify, and configure the new system component 110.

One embodiment can include advanced scheduling features to improve the overall pool user experience based on user preferences, which in some examples can be detected automatically using the Internet of Things or other integrated automation systems.

In some examples, the system components 102 can be detected, identified, and configured automatically by a user taking a photo of a pool pad. In some examples, this can be completed through a mobile application, advanced visual technologies like virtual reality, augmented reality, smart glasses, cameras, etc.

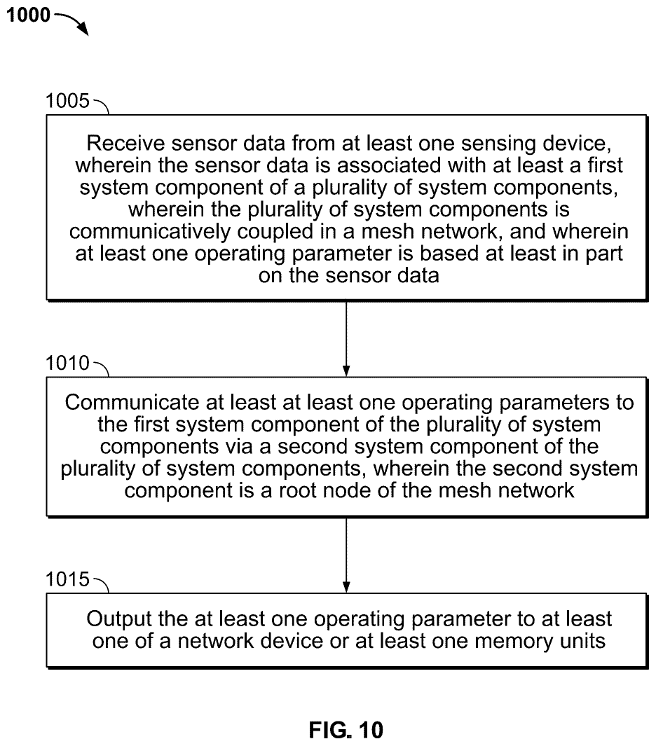

FIG. 10 is a flow diagram of an example process 1000 for monitoring and updating aquatic equipment (e.g., one or more system components 102) of the connected aquatic system 100 of FIG. 1. The operations of the process 1000 may be implemented by a connected system 100 or its components as described herein. For example, the operations of the process 1000 may be performed by a system component 102 or 110, a root node 104, or a network 108 as described with reference to FIGS. 1-6 and 9. In some examples, a system component 102 or 110, a root node 104, or a network 108 may execute a set of instructions to control the functional elements of the system component 102 or 110, the root node 104, or the network 108 to perform the described functions. Additionally, or alternatively, the system component 102 or 110, the root node 104, or the network 108 may perform aspects of the described functions using special-purpose hardware. In other examples, other components of the connected system 100 may perform aspects of the described functions.

At 1005, the process 1000 may include receiving sensor data from at least one sensing device, wherein the sensor data is associated with at least a first system component of a plurality of system components, wherein the plurality of system components is communicatively coupled in a mesh network, and wherein at least one operating parameter is based at least in part on the sensor data. The operations of 1005 may be performed in accordance with examples as disclosed herein. In some examples, aspects of the operations of 1005 may be performed by a system component 102 or 110 as described at least with reference to FIG. 1. In some examples, the first system component is an existing aquatic device or a new aquatic device.

At 1010, the process 1000 may include communicating at least one operating parameter to at least the first system component of the plurality of system components via a second system component of the plurality of system components, wherein the second system component is a root node of the mesh network. The operations of 1005 may be performed in accordance with examples as disclosed herein. In some examples, aspects of the operations of 1010 may be performed by a system component 102 or 110 as described at least with reference to FIG. 1.

At 1015, the process 1000 may include outputting the at least one operating parameter to at least one of a network device or at least one memory unit. The operations of 1015 may be performed in accordance with examples as disclosed herein. In some examples, aspects of the operations of 1010 may be performed by a system component 102 or 110 as described at least with reference to FIG. 1. In some examples, the operations of 1010 may be performed by a root node 104 as described at least with reference to FIG. 1.

In some examples, the process 1000 may further include aggregating at least one data set from the sensor data and outputting the at least one data set to a backend server communicatively coupled with at least the root node of the mesh network. In some examples, aspects of the operations may be performed by a system component 102 or 110 as described at least with reference to FIG. 1. In some examples, the operations may be performed by a root node 104 as described at least with reference to FIG. 1.

In some examples, the process 1000 may further include receiving a request from at least one third system component of the plurality of system components for information related to at least one operating parameter associated with the third system component(s) of the plurality of system components. The process 1000 may further include receiving at least one data set associated with the at least one operating parameter from at least one of the network devices or the at least one memory unit based at least in part on the request. The process 1000 may also include outputting the at least one data set associated with the at least one operating parameter to the third system component(s) of the plurality of system components. In some examples, aspects of the operations may be performed by a system component 102 or 110 as described at least with reference to FIG. 1. In some examples, the operations may be performed by a root node 104 as described at least with reference to FIG. 1. In some examples, the third system component may be the same as or different from the first system component or the second system component.

In other examples, the process 1000 may further include receiving a request to subscribe a third system component of the plurality of system components to a topic update and outputting at least one operating parameter associated with the sensor data and related to the topic update to the third system component of the plurality of system components based at least in part on the request to subscribe. In some examples, aspects of the operations may be performed by a system component 102 or 110 as described at least with reference to FIG. 1. In some examples, the operations may be performed by a root node 104 as described at least with reference to FIG. 1. In some examples, the third system component may be the same or different from the first system component or the second system component.

In other examples, the process 1000 may further include storing the sensor data with at least one identification element associated with the sensor data in at least one memory unit, wherein each of the at least one identification element is associated with one system component of the plurality of system components. In some examples, aspects of the operations may be performed by a system component 102 or 110 as described at least with reference to FIG. 1. In some examples, the operations may be performed by a root node 104 as described at least with reference to FIG. 1.

In additional examples, the process 1000 may further include performing an analytical analysis of the sensor data and outputting an instruction to at least one of the plurality of system components to adjust at least one setting based at least in part on the analytical analysis of the sensor data. In some examples, aspects of the operations may be performed by a system component 102 or 110 as described at least with reference to FIG. 1. In some examples, the operations may be performed by a root node 104 as described at least with reference to FIG. 1. In some examples, the operations may be performed at a network, such as the network 108 as described at least with reference to FIG. 1.

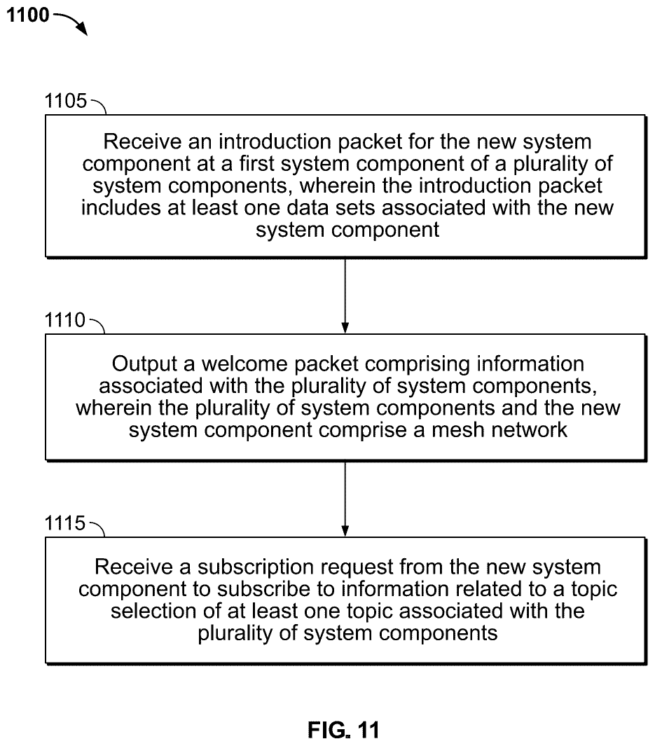

FIG. 11 is a flow diagram of an example process for configuring a new system component the connected aquatic system of FIG. 1. The operations of the process 1100 may be implemented by a connected system 100 or its components as described herein. For example, the operations of the process 1000 may be performed by a system component 102 or 110, a root node 104, or a network 108 as described with reference to FIGS. 1-6 and 9. In some examples, a system component 102 or 110, a root node 104, or a network 108 may execute a set of instructions to control the functional elements of the system component 102 or 110, the root node 104, or the network 108 to perform the described functions. Additionally, or alternatively, the system component 102 or 110, the root node 104, or the network 108 may perform aspects of the described functions using special-purpose hardware. In other examples, other components of the connected system 100 may perform aspects of the described functions.

At 1105, the process 1100 may include receiving an introduction packet for the new system component at a first system component of a plurality of system components, wherein the introduction packet includes at least one data set associated with the new system component. The operations of 1105 may be performed in accordance with examples as disclosed herein. In some examples, aspects of the operations of 1105 may be performed by a system component 102 or 110 as described at least with reference to FIG. 1. In some examples, the first system component is existing aquatic equipment (i.e., already connected to the system 100).

At 1110, the process 1100 may include outputting a welcome packet comprising information associated with the plurality of system components, wherein the plurality of system components and the new system component comprise a mesh network. The operations of 1110 may be performed in accordance with examples as disclosed herein. In some examples, aspects of the operations of 1110 may be performed by a system component 102 or 110 as described at least with reference to FIG. 1.

At 1115, the process 1100 may include receiving a subscription request from the new system component to subscribe to information related to a topic selection of at least one topic associated with the plurality of system components. The operations of 1115 may be performed in accordance with examples as disclosed herein. In some examples, aspects of the operations of 1115 may be performed by a system component 102 or 110 as described at least with reference to FIG. 1. In some examples, the first system component is existing aquatic equipment.

In some examples, the process 1100 may further include outputting information related to the at least one topic to the new system component based on the subscription request. In some examples, the process 1100 may further include storing subscription information associated with the subscription request and the topic selection in a database stored in at least one memory unit. The process 1100 may be performed in accordance with examples as disclosed herein. In some examples, aspects of the operations of the process 1100 may be performed by a system component 102 or 110 as described at least with reference to FIG. 1.

In other examples, the process 1100 may further include receiving sensor data from at least one sensing device associated with at least at least one of the plurality of system components, wherein the information related to the topic selection is based at least in part on the sensor data. In some examples, the process 1100 may further include aggregating at least one data set from the sensor data and outputting the at least one data set to a backend server communicatively coupled with at least a root node of the mesh network. The process 1100 may be performed in accordance with examples as disclosed herein. In some examples, aspects of the operations of the process 1100 may be performed by a system component 102 or 110 as described at least with reference to FIG. 1.

In other examples, the process 1100 may further include outputting an indication to a first system component of the plurality of system components to update at least one setting at the first system component based at least in part on the sensor data. The process 1100 may be performed in accordance with examples as disclosed herein. In some examples, aspects of the operations of the process 1100 may be performed by a system component 102 or 110 as described at least with reference to FIG. 1.

Information and signals described herein may be represented using any of a variety of different technologies and techniques. For example, data, instructions, commands, information, signals, bits, symbols, and chips that may be referenced throughout the description may be represented by electromagnetic waves, voltages, currents, magnetic fields or particles, optical fields or particles, or any combination thereof.

The various illustrative blocks and components described in connection with the disclosure herein may be implemented or performed using a general-purpose processor, a digital signal processor (DSP), an application specific integrated circuit (ASIC), a central processing unit (CPU), a graphics processing unit (GPU), a neural processing unit (NPU), a field programmable gate array (FPGA) or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by one or more processors, firmware, or any combination thereof. If implemented using software executed by one or more processors, the functions may be stored as or transmitted using one or more instructions or code of a computer-readable medium. Other examples and implementations are within the scope of the disclosure and appended claims. For example, due to the nature of software, functions described herein may be implemented using software executed by one or more processors, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include random access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B. For example, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), identifying, ascertaining, and the like. Also, “determining” can include receiving (e.g., receiving information), accessing (e.g., accessing data stored in memory), retrieving, and the like. Also, “determining” can include resolving, obtaining, selecting, choosing, establishing, and other such similar actions.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

In other instances, other configurations of the systems and methods described herein are possible. For example, those of skill in the art will recognize, according to the principles and concepts disclosed herein, that various combinations, sub-combinations, and substitutions of the components discussed above can provide appropriate control for a variety of different configurations of robotic platforms for a variety of applications.

It will be appreciated that while the system has been described above in connection with particular examples and examples, the system is not necessarily so limited and that numerous other examples, examples, uses, modifications, and departures from the examples, examples, and uses are intended to be encompassed by the claims attached hereto. The entire disclosure of each patent and publication cited herein is incorporated by reference as if each such patent or publication were individually incorporated by reference herein. Various features and advantages of the system are outlined in the following claims.

What is claimed is:

1. A system for aquatic equipment, comprising:
a plurality of system components of a connected system of the aquatic equipment;
a subset of the plurality of system components communicatively coupled in a mesh network, and a first system component of the plurality of system components provided in the form of a root node of the mesh network; and
a sensing device adapted to capture sensor data associated with at least one system component of the plurality of system components, wherein the root node of the mesh network is adapted to communicate at least a subset of the sensor data to at least one other system component of the plurality of system components.

2. The system of claim 1, further comprising:
a new system component designed to transmit an introduction packet including at least one data set, and receive a welcome packet comprising information associated with the plurality of system components.

3. The system of claim 1, further comprising:
at least one memory unit adapted to store at least one operating parameter associated with the sensor data in at least one dataset in a database or a lookup table.

4. The system of claim 1, further comprising:
a controller in communication with at least a subset of the system components designed to retrieve at least one information element from the at least one data set stored at the at least one memory unit, and output the at least one information element to at least a subset of the plurality of system components.

5. The system of claim 1, wherein the root node of the mesh network is adapted to communicate at least the subset of sensor data to a cloud network.

6. The system of claim 1, wherein the root node of the mesh network is adapted to aggregate at least one data set from the sensor data and communicate the at least one data set to a backend server.

7. The system of claim 1, wherein the at least one sensing device is integrated into a user device or connected to at least one system component of the plurality of system components.

8. The system of claim 1, wherein the plurality of system components includes two or more of at least one of a pool pump, a booster pump, a filter, a solar controller, a solar panel, a heater, a sanitizer, a water quality monitor, a pH regulator, a water feature, a pool cleaner, a pool skimmer, a pool drain, a pool light, and a salt chlorine generator.

9. A method for monitoring and updating aquatic equipment, comprising:
receiving sensor data from at least one sensing device, wherein the sensor data is associated with a first system component of a plurality of system components, the plurality of system components is communicatively coupled in a mesh network, and at least one operating parameter is based at least in part on the sensor data;
communicating at least one operating parameter to the first system component of the plurality of system components via a second system component of the plurality of system components, wherein the second system component is a root node of the mesh network; and
outputting the at least one operating parameter to at least one of a network device or at least one memory unit.

10. The method of claim 9, further comprising:
aggregating at least one data set from the sensor data; and
outputting the at least one data set to a backend server communicatively coupled with at least the root node of the mesh network.

11. The method of claim 9, further comprising:
receiving a request from at least a third system component of the plurality of system components for information related to at least one operating parameter associated with the third system component;
receiving at least one data set associated with the at least one operating parameter from at least one of the network devices or the at least one memory unit based at least in part on the request; and
outputting the at least one data set associated with the at least one operating parameters to the third system component.

12. The method of claim 9, further comprising:
receiving a request to subscribe a third system component of the plurality of system components to a topic update; and
outputting at least one operating parameter associated with the sensor data and related to the topic update to the third system component of the plurality of system components based at least in part on the request to subscribe.

13. The method of claim 9, further comprising:
storing the sensor data with at least one identification elements associated with the sensor data in at least one memory unit, wherein each of the at least one identification elements is associated with one system component of the plurality of system components.

14. The method of claim 9, further comprising:
performing an analytical analysis of the sensor data; and
outputting an instruction to at least one of the plurality of system components to adjust at least one setting based at least in part on the analytical analysis of the sensor data.

15. A method for configuring a new system component for an aquatic application, comprising:
receiving an introduction packet for the new system component at a first system component of a plurality of system components, wherein the introduction packet includes at least one data set associated with the new system component;
outputting a welcome packet defined by information associated with the plurality of system components, wherein the plurality of system components and the new system component comprise a mesh network; and
receiving a subscription request from the new system component to subscribe to information related to a topic selection of at least one topic associated with the plurality of system components.

16. The method of claim 15 further comprising outputting information related to the at least one topic to the new system component based on the subscription request.

17. The method of claim 15 further comprising storing subscription information associated with the subscription request and the topic selection in a database stored in at least one memory unit.

18. The method of claim 15 further comprising receiving sensor data from at least one sensing device associated with one of the plurality of system components, wherein the information related to the topic selection is based at least in part on the sensor data.

19. The method of claim 18, further comprising:
aggregating at least one data set from the sensor data; and
outputting the at least one data set to a backend server communicatively coupled with at least a root node of the mesh network.

20. The method of claim 18, further comprising outputting an indication to a first system component of the plurality of system components to update at least one setting at the first system component based at least in part on the sensor data.
